(19) United States
(12) Patent Application Publication
(10) Pub. No.: US 2012/0035927 A1
(43) Pub. Date: Feb. 9, 2012

(54) Information Processing Apparatus, Information Processing Method, and Program

(76) Inventors: Keiichi Yamada, Tokyo (JP); Tsutomu Sawada, Tokyo (JP)

(21) Appl. No.: 13/174,807

(22) Filed: Jul. 1, 2011

(30) Foreign Application Priority Data
Aug. 9, 2010 (JP) P2010-178424

(51) Int. Cl. G10L 15/00

(52) U.S. Cl. 704/242; 704/231; 704/E15.001

(57) ABSTRACT

An information processing apparatus includes a plurality of information input units that inputs observation information of a real space, an event detection unit that generates event information including estimated position information and estimated identification (ID) information of a user present in the real space based on analysis of the information input from the information input unit, and an information integration processing unit that inputs the event information, and generates target information including a position and user ID information of each user based on the input event information and signal information representing a probability value for an event generating source. Here, the information integration processing unit includes an utterance source probability calculation unit having an identifier, and calculates an utterance source probability based on input information using the identifier in the utterance source probability calculation unit.

### BACKGROUND

The present disclosure relates to an information processing apparatus, an information processing method, and a program, and more particularly, to an information processing apparatus, an information processing method, and a program which analyze an external environment based on input information by inputting the input information from the outside world, for example, information such as images, voices, and the like, and specifically, analyzes a position of a person uttering words, who is uttering words, and the like.

A system that performs an interactive process between information processing apparatuses such as a person, a PC (Personal Computer), and a robot, for example, a communication process or an interactive process is referred to as a man-machine interaction system. In the man-machine interaction system, the information processing apparatuses such as the PC, the robot, and the like perform analysis based on input information by inputting image information or voice information to recognize human actions such as human behavior or words.

In the case where a person transmits information, various channels for gestures, gaze, facial expressions, and the like as well as words are used as information transmission channels. When being able to analyze these channels in the machine, even communication between people and machines may reach the same level as that of communication between people. An interface capable of analyzing input information from these multi-channels (also referred to as modality or modal) is called a multi-modal interface, and development and studies for the interface have been extensively conducted.

For example, when performing analysis by inputting image information captured by a camera and sound information obtained by a microphone, more specifically to perform analysis, inputting a large amount of information from a plurality of cameras and a plurality of microphones which are positioned at various points is effective.

As a specific system, for example, the following system is assumed. An information processing apparatus (television) inputs images and voices of users (father, mother, sister, and brother) in front of the television via the camera and the microphone, and analyzes a position of each of the users, which user utters words, and the like, so that a system capable of performing processes according to analysis information such as the camera zooming-in with respect to the user who has spoken, making an adequate response with respect to the user who has spoken, or the like may be realized.

As the related art in which an existing man-machine interaction system is disclosed, for example, Japanese Unexamined Patent Application Publication No. 2009-31951 and Japanese Unexamined Patent Application Publication No. 2009-140366 are given. In this related art, a process in which information from multi-channel (modal) is integrated in a probabilistic manner, and a position of each of a plurality of users, who a plurality of users is, and who issues signals, that is, who utters words are determined with respect to each of a plurality of users is performed.

For example, when determining who issues the signals, virtual targets (tID=1 to m) equivalent to the plurality of users are set, and a probability in which each of the targets is an utterance source is calculated from analysis results of image data captured by the camera or sound information obtained by the microphone.

Specifically, for example, the following process is performed.

(a) Sound source direction information of a voice event obtained via the microphone, user position information obtainable from utterer identification (ID) information, and an utterance source probability P (tID) of a target tID obtainable from only the user ID information.

(b) An area S_{Δt}(tID) of a face attribute score [S(tID)] obtained by a face recognition process based on images obtainable via a camera.

Wherein (a) and (b) are calculated to thereby calculate an utterer probability Ps(tID) or Pp(tID) of each (tID=1 to m) of the targets by addition or multiplication based on weight α using α as a preset allocation weight coefficient.

In addition, details of this process are described in, for example, Japanese Unexamined Patent Application Publication No. 2009-140366.

In the calculation process of the utterer probability in the above described related art, it is necessary that the weight coefficient α is adjusted beforehand as described above. Adjusting the weight coefficient beforehand is cumbersome, and when the weight coefficient is not adjusted to a suitable numerical value, there is a problem that greatly affects validity itself of the calculation result of the utterer probability.

### SUMMARY

The present disclosure is to solve the above problem, and it is desirable to provide an information processing apparatus, an information processing method, and a program, which may perform a process for integrating to information estimated to be more accurate by performing a stochastic process with respect to uncertain information included in various input information such as image information, sound information, and the like in a system for performing analysis of input information from a plurality of channels (modality or modal), more specifically, specific processes concerning, for example, a position, and the like of the person in the surroundings, so that robustness may be improved, and highly accurate analysis may be performed.

The present disclosure is to solve the above problem, and it is desirable to provide an information processing apparatus, an information processing method, and a program, which may use an identifier with respect to voice event information equivalent to utterance of a user from within input event information when calculating an utterance source probability, so that it is not necessary for the above described weight coefficient to be adjusted beforehand.

According to an embodiment of the present disclosure, there is provided an information processing apparatus, including: a plurality of information input units that inputs observation information of a real space; an event detection unit that generates event information including estimated position information and estimated identification (ID) information of a user present in the real space based on analysis of the information input from the information input unit; and an information integration processing unit that inputs the event information, and generates target information including a position and user ID information of each user based on the input event information and generates signal information representing a probability value for an event generating source. Here, the information integration processing unit may include an utterance source probability calculation unit having an identifier, and calculate an utterance source probability based on input information using the identifier in the utterance source probability calculation unit.

In addition, according to the embodiment of the information processing apparatus of the present disclosure, the identifier may input (a) user position information (sound source direction information) and (b) user ID information (utterer ID information) which are equivalent to an utterance event as input information from a voice event detection unit constituting the event detection unit, also input (a) user position information (face position information), (b) user ID information (face ID information), and (c) lip movement information as the target information generated based on input information from an image event detection unit constituting the event detection unit, and perform a process of calculating the utterance source probability based on the input information by applying at least one piece of the information.

In addition, according to an embodiment of the information processing apparatus of the present disclosure, the identifier may perform a process of identifying which one of target information of two targets selected from a preset target is an utterance source based on a comparison between the target information of the two targets.

In addition, according to the embodiment of the information processing apparatus of the present disclosure, the identifier may calculate a logarithmic likelihood ratio of each piece of information included in target information in a comparison process of the target information of a plurality of targets included in the input information with respect to the identifier, and perform a process of calculating an utterance source score representing the utterance source probability according to the calculated logarithmic likelihood ratio.

In addition, according to the embodiment of the information processing apparatus of the present disclosure, the identifier may calculate at least any logarithmic likelihood ratio of three kinds of logarithmic likelihood ratios such as log(D₁/D₂), log(S₁/S₂), and log(L₁/L₂) as a logarithmic likelihood ratio of two targets 1 and 2 using sound source direction information (D), utterer ID information (S), and lip movement information (L) acting as the input information with respect to the identifier to thereby calculate the utterance source score as the utterance source probability of the targets 1 and 2.

In addition, according to the embodiment of the information processing apparatus of the present disclosure, the information integration processing unit may include a target information updating unit that performs a particle filtering process in which a plurality of particles is applied, the plurality of particles setting a plurality of target data corresponding to a virtual user based on the input information from the image event detection unit constituting the event detection unit, and generate analysis information including the position information of the user present in the real space. Here, the target information updating unit may set by associating each packet of target data set by the particles with each event input from the event detection unit, perform updating of event correspondence target data selected from each of the particles in accordance with an input event identifier, and generate the target information including (a) user position information, (b) user ID information, and (c) lip movement information to thereby output the generated target information to the utterance source probability calculation unit.

In addition, according to the embodiment of the information processing apparatus of the present disclosure, the target information updating unit may perform a process by associating a target with each event of a face image unit detected in the event detection unit.

In addition, according to the embodiment of the information processing apparatus of the present disclosure, the target information updating unit may generate the analysis information including the user position information and the user ID information of the user present in the real space by performing the particle filtering process.

According to another embodiment of the present disclosure, there is provided an information processing method for performing an information analysis process in an information processing apparatus, the method including: inputting observation information of a real space by a plurality of information input units; detecting generation of event information including estimated position information and estimated ID information of a user present in the real space based on analysis of information input from the information input unit by an event detection unit; and inputting the event information by an information integration processing unit, and generating target information including a position and user ID information of each user based on the input event information and signal information representing a probability value for an event generating source. Here, in the inputting of the event information and the generating of the target information and the signal information, an utterance source probability calculation process may be performed using an identifier for calculating an utterance source probability based on input information when generating the signal information representing the probability of the event generating source.

According to still another embodiment of the present disclosure, there is provided a program for performing an information analysis process in an information processing apparatus, the program including: inputting observation information of a real space by a plurality of information input units; detecting generation of event information including estimated position information and estimated ID information of a user present in the real space based on analysis of information input from the information input unit by an event detection unit; and inputting the event information by an information integration processing unit, and generating target information including a position and user ID information of each user based on the input event information and generating signal information representing a probability value for an event generating source. Here, in the inputting of the event information and the generating of the target information and the signal information, an utterance source probability calculation process may be performed using an identifier for calculating an utterance source probability based on input information when generating the signal information representing the probability of the event generating source.

In addition, the program of the present disclosure may be a program that can be provided by a storage medium and a communication medium provided in a computer-readable format, with respect to an information processing apparatus or a computer system that can perform a variety of program codes. By providing the program in the computer-readable format, processes according to the program may be realized in the information processing apparatus or the computer system.

Other objects, features, and advantages of the present disclosure will become apparent from more detailed descriptions based on embodiments of the present disclosure described below and the accompanying drawings. Further, the system throughout the present specification is composed of a logical assembly of a plurality of devices, and devices of each configuration are not limited to being present within the same casing.

According to a configuration of the embodiment of the present disclosure, a configuration that generates a user position, identification (ID) information, utterer information, and the like by information analysis based on uncertain and asynchronous input information is realized. The information processing apparatus of the present disclosure may include an information integration processing unit that inputs event information including estimated position and estimated ID data of a user based on image information or voice information, and generates target information including a position and user ID information of each user based on the input event information and signal information representing a probability value for an event generating source. Here, the information integration processing unit includes an utterance source probability calculation unit with an identifier, and calculates an utterance source probability based on the input information using the identifier in the utterance source probability calculation unit. For example, the identifier calculates a logarithmic likelihood ratio of, for example, user position information, user ID information, and lip movement information to thereby generate signal information representing a probability value for an event generation source, whereby a highly accurate process in specifying an utterer is realized.

### BRIEF DESCRIPTION OF THE DRAWINGS

FIG. 1 is a diagram for describing an overview of a process performed by an information processing apparatus according to an embodiment of the present disclosure;

FIG. 2 is a diagram for describing a configuration and a process of an information processing apparatus according to an embodiment of the present disclosure;

FIGS. 3A and 3B are diagrams for describing an example of information that is generated by a voice event detection unit and an image event detection unit, and is input to an information integration processing unit;

FIGS. 4A-4C are diagrams for describing a basic processing example to which a particle filter is applied;

FIG. 5 is a diagram for describing a configuration of particles set in the present processing example;

FIG. 6 is a diagram for describing a configuration of target data of each target included in respective particles;

FIG. 7 is a diagram for describing a configuration and a generation process of target information;

FIG. 8 is a diagram for describing a configuration and a generation process of target information;

FIG. 9 is a diagram for describing a configuration and a generation process of target information;

FIG. 10 is a flowchart illustrating a processing sequence performed by an information integration processing unit;

FIG. 11 is a diagram for describing a calculation process of a particle weight, in detail;

FIG. 12 is a diagram for describing an utterer specification process;

FIG. 13 is a flowchart illustrating an example of a processing sequence performed by an utterance source probability calculation unit;

FIG. 14 is a flowchart illustrating an example of a processing sequence performed by an utterance source probability calculation unit;

FIG. 15 is a diagram for describing an example of an utterance source score calculated by a process performed by an utterance source probability calculation unit;

FIG. 16 is a diagram for describing an example of utterance source estimated information obtained by a process performed by an utterance source probability calculation unit;

FIG. 17 is a diagram for describing an example of utterance source estimated information obtained by a process performed by an utterance source probability calculation unit;

FIG. 18 is a diagram for describing an example of utterance source estimated information obtained by a process performed by an utterance source probability calculation unit; and

FIG. 19 is a diagram for describing an example of utterance source estimated information obtained by a process performed by an utterance source probability calculation unit.

### DETAILED DESCRIPTION OF EMBODIMENTS

Hereinafter, an information processing apparatus, an information processing method, and a program according to exemplary embodiments of the present disclosure will now be described in detail with reference to the accompanying drawings. Further, the description will be made according to the following items:

1. Overview of a process performed by an information processing apparatus of the present disclosure

2. Details of a configuration and a process of an information processing apparatus of the present disclosure

3. Processing sequence performed by an information processing apparatus of the present disclosure

4. Details of a process performed by an utterance source probability calculation unit

<1. Overview of a Process Performed by an Information Processing Apparatus of the Present Disclosure>

First, an overview of a process performed by an information processing apparatus of the present disclosure will be described.

The present disclosure realizes a configuration in which an identifier is used with respect to voice event information equivalent to utterance of a user from within input event information when calculating an utterance source probability, so that it is not necessary that a weight coefficient described in BACKGROUND is adjusted beforehand.

Specifically, an identifier for identifying whether each of targets is an utterance source, or an identifier for determining which one of two pieces of target information seems more to be an utterance source with respect to only two pieces of target information is used. As the input information to the identifier, sound source direction information or utterer identification (ID) information included in voice event information, lip movement information included in image event information from within event information, and a target position or a total number of targets included in target information are used. By using the identifier when calculating the utterance source probability, it is not necessary that the weight coefficient described in BACKGROUND is adjusted beforehand, thereby it is possible to calculate more appropriate utterance source probability.

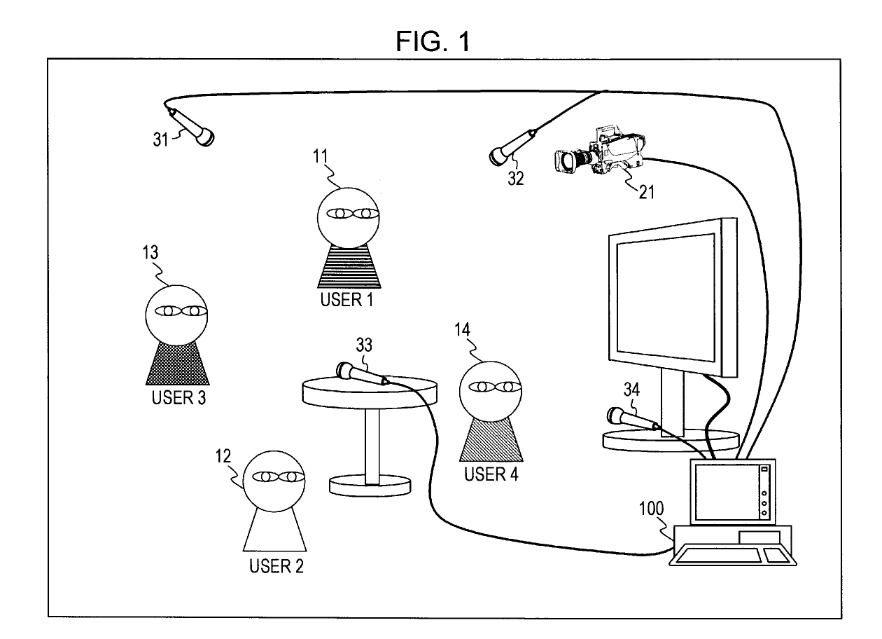

First, an overview of a process performed by an information processing apparatus according to the present disclosure will be described with reference to FIG. 1. The information processing apparatus 100 of the present disclosure inputs image information and voice information from a sensor in which observation information in real time is input, here for example, a camera 21 and a plurality of microphones 31 to 34, and perform analysis of the environment based on the input information. Specifically, position analysis of a plurality of users 1, 11 to 4, and 14, and identification (ID) of the user of the corresponding position are performed.

In an example shown in drawing, for example, in the case of a father, mother, sister, and brother in which the users 1, 11 to 4, and 14 are the family, the information processing apparatus 100 performs analysis of the image information and the voice information input from the camera 21 and the plurality of microphones 31 to 34 to thereby identify positions of four users 1 to 4, and which one of the father, mother, sister, and brother is positioned in each of the positions. The identified result is used for various processes. For example, the identified result is used for a process such as a camera zooming-in of on a user who has spoken, a television making a response with respect to the user having the conversation, or the like.

In addition, as a main process of the information processing apparatus 100 according to the present disclosure, a user position and a user as a specification process of the user are identified based on input information from a plurality of information input units (camera 21, and microphones 31 to 34). Usages of the identified result are not particularly limited. Various uncertain information is included in the image information and the voice information input from the camera 21 and the plurality of microphones 31 to 34. In the information processing apparatus 100 according to the present disclosure, a stochastic process is performed with respect to the uncertain information included in the input information, and the information being subjected to the stochastic process is integrated to information estimated to be highly accurate. By this estimation process, robustness is improved to thereby perform analysis with high accuracy.

<2. Details of a Configuration and a Process of an Information Processing Apparatus of the Present Disclosure>

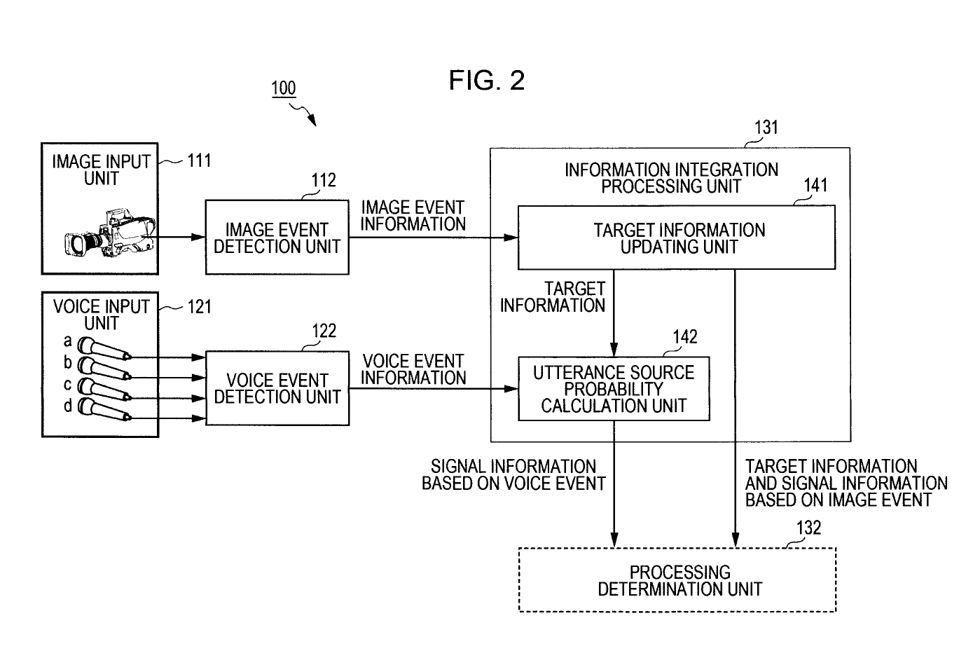

In FIG. 2, a configuration example of the information processing apparatus 100 is illustrated. The information processing apparatus 100 includes an image input unit (camera) 111 and a plurality of voice input units (microphones) 121a to 121d as an input device. The information processing apparatus 100 inputs image information from the image input unit (camera) 111, and inputs voice information from the voice input unit (microphones) 121 to thereby perform analysis based on this input information. Each of the plurality of voice input units (microphones) 121a to 121d is disposed in various positions shown in FIG. 1.

The voice information input from the plurality of microphones 121a to 121d is input to an information integration processing unit 131 via a voice event detection unit 122. The voice event detection unit 122 analyzes and integrates voice information input from the plurality of voice input units (microphones) 121a to 121d disposed in a plurality of different positions. Specifically, a position in which sound is generated and user ID information indicating which user generates the sound are generated based on the voice information input from the voice input units (microphones) 121a to 121d, and inputs the generated information to the information integration processing unit 131.

In addition, as a specific process performed by the information processing apparatus 100, identifying a position of each user A to D and which one of users A to D has spoken in an environment where there is a plurality of users shown in FIG. 1, that is, performing a user position and a user ID is given. Specifically, the specific process is a process for specifying an event generation source such as a person (utterer) who utters words, or the like.

The voice event detection unit 122 analyzes the voice information input from the plurality of voice input units (microphones) 121a to 121d disposed in a plurality of different positions, and generates position information of a voice generation source as probability distribution data. Specifically, the voice event detection unit 122 generates an expected value and distribution data N(mₑ,σₑ) with respect to a sound source direction. In addition, the voice event detection unit 122 generates user ID information based on a comparison with feature information of a voice of a user that is registered in advance. The ID information is also generated as a probabilistic estimated value. Since feature information of voices of a plurality of users to be verified in advance is registered in the voice event detection unit 122, a comparison between input voice and registered voice is performed, and a process of determining which user's voice corresponds to the high probability input voice is performed, such that a posterior probability or a score with respect to all of the registered users is calculated.

In this manner, the voice event detection unit 122 analyzes the voice information input from the plurality of voice input units (microphones) 121a to 121d disposed in the plurality of different positions, generates “integrated voice event information” configured by probability distribution data as position information of a generation source of the voice, and user ID information constituted by a probabilistic estimated value, and inputs the generated integrated voice event information to the information integration processing unit 131.

Meanwhile, the image information input from the image input unit (camera) 111 is input to the information integration processing unit 131 via the image event detection unit 112. The image event detection unit 112 analyzes the image information input from the image input unit (camera) 111, extracts a face of a person included in the image, and generates position information of the face as probability distribution data. Specifically, an expected value for a position or a direction of the face, and distribution data N(mₑ,σₑ) are generated.

In addition, the image event detection unit 112 identifies a face by performing a comparison with feature information of a user's face that is registered in advance, and generates user ID information. The ID information is generated as a probabilistic estimated value. Since feature information with respect to faces of a plurality of users to be verified in advance is registered in the image event detection unit 112, a comparison between feature information of an image of a face area extracted from an input image and feature information of a registered face image is performed, a process of determining which user's face corresponds to the high probability input image is determined, so that a posterior probability or a score with respect to all of the registered users is calculated.

In addition, the image event detection unit 112 calculates an attribute score equivalent to a face included in the image input from the image input unit (camera) 111, for example, a face attribute score generated based on a movement of a mouth area.

It is possible to set so as to calculate the following various face attribute scores:

(a) a score equivalent to the movement of the mouth area of the face included in the image,

(b) a score set depending on whether the face included in the image is a smiling face or not,

(c) a score set depending on whether the face included in the image is a male face or a female face, and

(d) a score set depending on whether the face included in the image is an adult face or a face of a child.

In the embodiment described below, an example in which (a) a score equivalent to a movement of a mouth area of the face included in the image is calculated and used as the face attribute score is described. That is, the score equivalent to the movement of the mouth area of the face is calculated as the face attribute score, and specification of an utterer is performed based on the face attribute score.

The image event detection unit 112 identifies the mouth area from the face area included in the image input from the image input unit (camera) 111, and detects a movement of the mouth area, so that a score with a higher value is calculated in a case where it is determined that a score equivalent to a movement detection result is detected, for example, when the movement of the mouth area is detected.

In addition, a movement detection process of the mouth area is performed as a process to which a VSD (Visual Speech Detection) is applied. A method disclosed in Japanese Unexamined Patent Application Publication No. 2005-157679 relating to the application of the same applicant as that of the present disclosure is applied. Specifically, for example, left and right corners of the lips are detected from a face image detected from the image input from the image input unit (camera) 111, a difference in luminance is calculated after the left and right corners of the lips are aligned in an N-th frame and an (N+1)-th frame, and a value of the difference is processed as a threshold value, thereby detecting the movement of the lips.

In addition, techniques of the related art may be applied to the voice ID process performed in the voice event detection unit 122 or the image event detection unit 112, a face detection process, or a face ID process. For example, a technique disclosed in the following document can be applied as the face detection process and the face ID process.

Sabe Kotaro, Hidai Kenichi, “Learning for real-time arbitrary posture face detectors using pixel difference characteristics”, the 10^{th} image sensing symposium proceedings, pp. 547 to 552, 2004 Japanese Unexamined Patent Application Publication No. 2004-302644 (P2004-302644 A)<<Title of the invention: Face ID apparatus, Face ID method, Recording medium, and Robot apparatus>

The information integration processing unit 131 performs a process of probabilistically estimating who each of a plurality of users is, a position of each of the plurality of users, and who generates signals such as a voice or the like, based on the input information from the voice event detection unit 122 or the image event detection unit 112.

Specifically, the information integration processing unit 131 outputs, to a processing determination unit 132, each piece of information such as (a) target information as estimation information concerning the position of each of the plurality of users, and who they are, and (b) signal information such as an event generation source of, for example, a user, or the like uttering words based on the input information from the voice event detection unit 122 or the image event detection unit 112.

In addition, the following two pieces of signal information are included in the signal information: (b1) signal information based on a voice event and (b2) signal information based on an image event.

A target information updating unit 141 of the information integration processing unit 131 performs target updating using, for example, a particle filter by inputting the image event information detected in the image event detection unit 112, and generates the target information and the signal information based on the image event to thereby output the generated information to the processing determination unit 132. In addition, the target information obtained as the updating result is output even to the utterance source probability calculation unit 142.

The utterance source probability calculation unit 142 of the information integration processing unit 131 calculates a probability in which each of the targets is a generation source of the input voice event using an ID model (identifier) by inputting the voice event information detected in the voice event detection unit 122. The utterance source probability calculation unit 142 generates signal information based on the voice event based on the calculated value, and outputs the generated information to the processing determination unit 132.

This process will be described later.

The processing determination unit 132 receiving the ID processing result including the target information and the signal information generated by the information integration processing unit 131 performs a process using the ID processing result. For example, processes such as a camera zooming-in with respect to, for example, a user who has spoken, or a television making a response with respect to the user who has spoken, or the like are performed.

As described above, the voice event detection unit 122 generates probability distribution data of position information of the generation source of a voice, and more specifically, an expected value and distribution data N(mₑ,σₑ) with respect to a sound direction. In addition, the voice event detection unit 122 generates user ID information based on a comparison result such as feature information of a user that is registered in advance, and inputs the generated information to the information integration processing unit 131.

In addition, the image event detection unit 112 extracts a face of a person included in the image, and generates position information of the face as probability distribution data. Specifically, the image event detection unit 112 generates an expected value and dispersion data N(mₑ,σₑ) with respect to a position and a direction of the face. In addition, the image event detection unit 112 generates user ID information based on a comparison process performed with the feature information of the face of the user that is registered in advance, and inputs the generated information to the information integration processing unit 131. In addition, the image event detection unit 112 detects a face attribute score as face attribute information from a face area within the image input from the image input unit (camera) 111, for example, a movement of a mouth area, calculates a score equivalent to the movement detection result of the mouth area, and more specifically, a face attribute score with a high value when a significant movement of the mouth area is detected, and inputs the calculated score to the information integration processing unit 131.

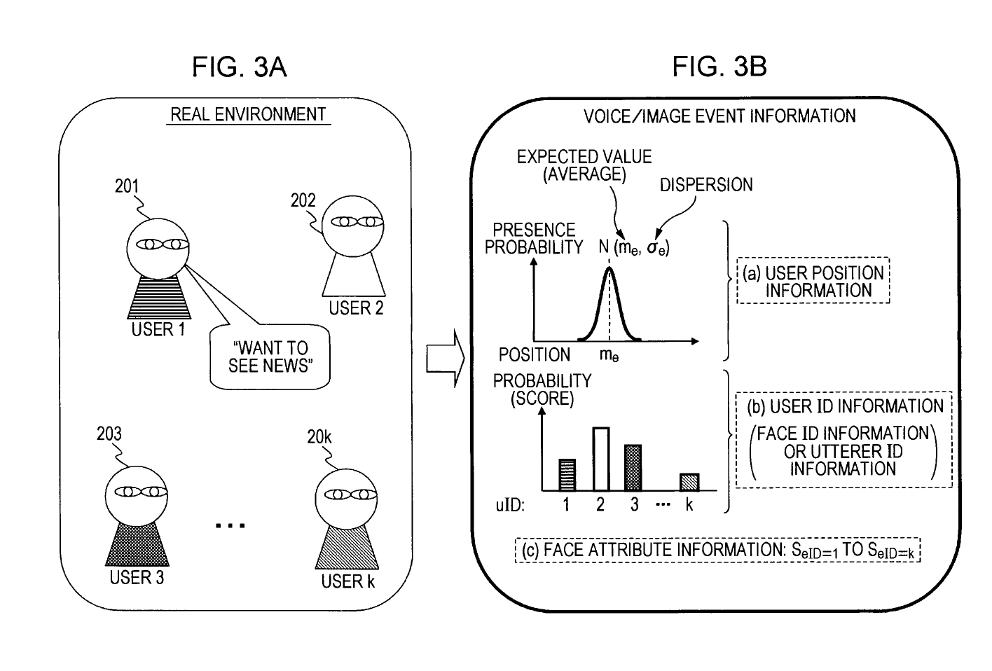

Referring to FIG. 3, examples of information that is generated by the voice event detection unit 122 and the image event detection unit 112, and inputs the generated information to the information integration processing unit 131 are described.

In the configuration of the present disclosure, the image event detection unit 112 generates data such as (Va) an expected value and dispersion data N(mₑ,σₑ) with respect to a position and a direction of a face, (Vb) user ID information based on feature information of a face image, and (Vc) a score equivalent to attributes of a detected face, for example, a face attribute score generated based on a movement of a mouth area, and inputs the generated data to the information integration processing unit 131.

In addition, the voice event detection unit 122 inputs, to the information integration processing unit 131, data such as (Aa) an expected value and dispersion data N(mₑ, σₑ) with respect to a sound source direction, and (Ab) user ID information based on voice characteristics.

An example of real environment including the same camera and the microphone as those described with reference to FIG. 1 is illustrated in FIG. 3A, and there is a plurality of users 1 to k, 201 to 20k. In this environment, when any one of the users utters words, the voice is input via the microphone. In addition, the camera continuously photographs images.

The information that is generated by the voice event detection unit 122 and the image event detection unit 112, and is input to the information integration processing unit 131 is classified into three types such as (a) user position information, (b) user ID information (face ID information or utterer ID information), and (c) face attribute information (face attribute score).

That is, (a) user position information is integrated information of (Va) an expected value and dispersion data N (mₑ,σₑ) with respect to a face position or direction, which is generated by the image event detection unit 112, and (Aa) an expected value and dispersion data (mₑ,σₑ) with respect to a sound source direction, which is generated by the voice event detection unit 122.

In addition, (b) user ID information (face ID information or utterer ID information) is integrated information of (Vb) user ID information based on feature information of a face image, which is generated by the image event detection unit 112, and (Ab) user ID information based on feature information of voice, which is generated by the voice event detection unit 122.

The (c) face attribute information (face attribute score) is equivalent to a score equivalent to the detected face attribute (Vc) generated by the image event detection unit 112, for example, a face attribute score generated based on the movement of the lip area.

The (a) user position information, the (b) user ID information (face ID information or utterer ID information), and the (c) face attribute information (face attribute score) are generated for each event.

When voice information is input from the voice input units (microphones) 121a to 121d, the voice event detection unit 122 generates the above described (a) user position information and (b) user ID information based on the voice information, and inputs the generated information to the information integration processing unit 131. The image event detection unit 112 generates the (a) user position information, the (b) user ID information, and the (c) face attribute information (face attribute score) based on the image information input from the image input unit (camera) 111 at a certain frame interval determined in advance, and inputs the generated information to the information integration processing unit 131. In addition, in this embodiment, the image input unit (camera) 111 shows an example in which a single camera is set, and images of a plurality of users are photographed by the single camera. In this case, the (a) user position information and the (b) user ID information are generated with respect to each of the plurality of faces included in a single image, and the generated information is input to the information integration processing unit 131.

A process in which the voice event detection unit 122 generates the (a) user position information and the (b) user ID information (utterer ID information) will be described based on the voice information input from the voice input unit (microphone) 121a to 121d.

<Process of Generating (a) User Position Information by the Voice Event Detection Unit 122>

The voice event detection unit 122 generates estimated information of a position of a user issued voice that is analyzed based on the voice information input from the voice input unit (microphone) 121a to 121d, that is, a position of an utterer. That is, the voice event detection unit 122 generates a position estimated to be where the utterer is, as Gaussian distribution (normal distribution) data N(mₑ,σTₑ) obtained from an expected value (average)[mₑ] and distribution information [σₑ].

<Process of Generating (B) User ID Information (Utterer ID Information) by the Voice Event Detection Unit 122>

The voice event detection unit 122 estimates who the utterer is based on the voice information input from the voice input unit (microphone) 121a to 121d, by a comparison between feature information of the input voice and feature information of the voices of users 1 to k registered in advance. Specifically, a probability that the utterer is each of the users 1 to k is calculated. The calculated value (b) is used as the user ID information (utterer ID information). For example, the highest score is distributed to a user having registered voice characteristics closest to characteristics of the input voice, and the lowest score (for example, zero) is distributed to a user having the most different characteristics from the characteristics of the input voice, so that data setting a probability that the input voice belongs to each of the users is generated, and the generated data is used as the (b) user ID information (utterer ID information).

Next, a process in which the image event detection unit 112 generates information such as (a) user position information, (b) user ID information (face ID information), and (c) face attribute information (face attribute score) based on the image information input from the image input unit (camera) 111 will be described.

<Process of Generating (a) User Position Information by Image Event Detection Unit 112>

The image event detection unit 112 generates estimated information of a face position with respect to each of faces included in the image information input from the image input unit (camera) 111. That is, a position estimated that the face detected from the image exists is generated as Gaussian distribution (normal distribution) data N(mₑ,σₑ) obtained from an expected value (average) [mₑ] and distribution information [σₑ].

<Process of Generating (B) User ID Information (Face ID Information) by the Image Event Detection Unit 112>

The image event detection unit 112 detects a face included in image information based on the image information input from the image input unit (camera) 111, and estimates who each of the faces is by a comparison between the input image information and feature information of a face of each user 1 to k registered in advance. Specifically, a probability that each extracted face is each of the users 1 to k is calculated. The calculated value is used as (b) user ID information (face ID information). For example, the highest score is distributed to a user having characteristics of a registered face closest to characteristics of a face included in the input image, and the lowest score (for example, zero) is distributed to a user having the most different characteristics from the characteristics of the face, so that data setting a probability that the input voice belongs to each user is generated, and the generated data is used as (b) user ID information (face ID information).

<Process of Generating (C) Face Attribute Information (Face Attribute Score) by the Image Event Detection Unit 112>

The image event detection unit 112 detects a face area included in the image information based on image information input from the image input unit (camera) 111, and calculates attributes of the detected face, specifically, attribute scores such as the above described movement of the mouth area of the face, whether the detected face is a smiling face, whether the detected face is a male face or a female face, whether the detected face is an adult face, and the like. However, in this processing example, an example in which a score equivalent to the movement of the mouth area of the face included in the image is calculated and used as the face attribute score will be described.

As the process of calculating the score equivalent to the movement of the lip area of the face, the image event detection unit 112 detects left and right corners of a lips from the face image detected from the image input from the image input unit (camera) 111, a difference in luminance is calculated after the left and right corners of the lips are aligned in an N-th frame and an (N+1)-th frame, and a value of the difference is processed as a threshold value. By this process, the movement of the lips is detected, a face attribute score in which a higher score is obtained with an increase in the movement of the lips is set.

In addition, when a plurality of faces is detected from an image photographed by the camera, the image event detection unit 112 generates event information equivalent to each of the faces as a separate event according to each of the detected faces. That is, the image event detection unit 112 generates the event information including the following information such as (a) user position information, (b) user ID information (face ID information), and (c) face attribute information (face attribute score), and inputs the generated information to the information integration processing unit 131.

In this embodiment, an example in which a single camera is used as the image input unit 111, however, images photographed by a plurality of cameras may be used. In this case, the image event detection unit 112 generates (a) user position information, (b) user ID information (face ID information), and (c) face attribute information (face attribute score) with respect to each of the faces included in each of the photographed images of the plurality of cameras, and inputs the generated information to the information integration processing unit 131.

Next, a process performed by the information integration processing unit 131 will be described. The information integration processing unit 131 inputs three pieces of information shown in FIG. 3B from the voice event detection unit 122 and the image event detection unit 112 as described above, that is, (a) user position information, (b) user ID information (face ID information or utterer ID information), and (c) face attribute information (face attribute score) in this stated order. In addition, a variety of settings are possible with respect to an input timing of the each piece of information above, however, for example, the voice event detection unit 122 generates and inputs each piece of information of the above (a) and (b) as the voice event information when a new voice is input, so that the image event detection unit 112 generates and inputs each piece of information of (a), (b), and (c) as voice event information in a certain frame period unit.

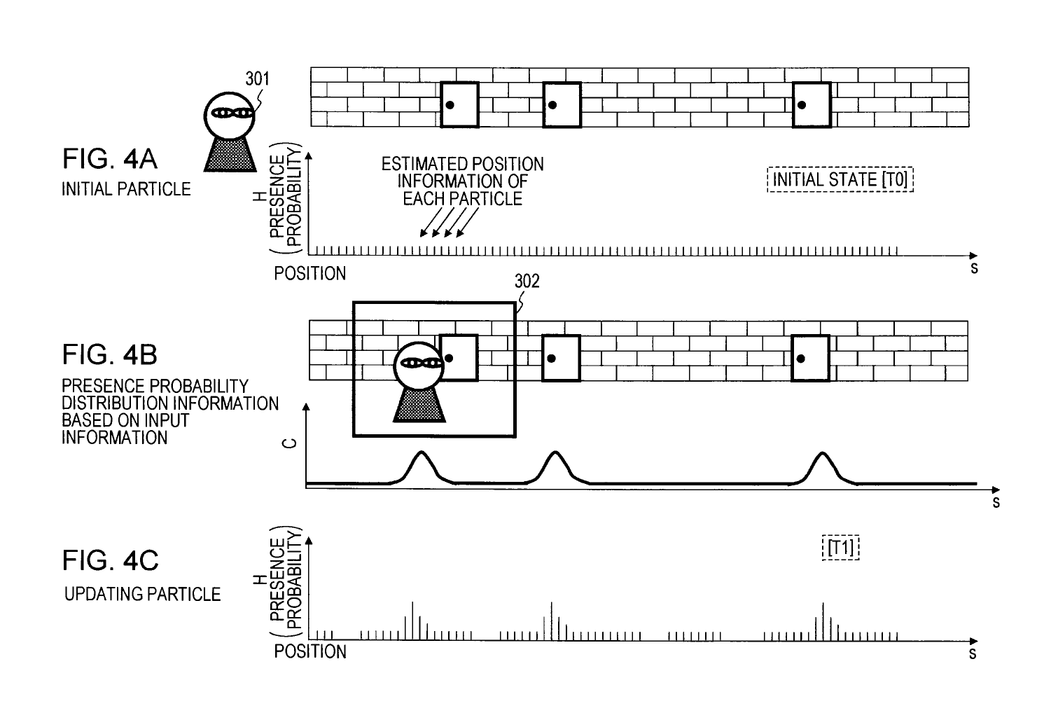

A process performed by the information integration processing unit 131 will be described with reference to FIG. 4.

As described above, the information integration processing unit 131 includes a target information updating unit 141 and an utterance source probability calculation unit 142, and performs the following processes.

The target information updating unit 141 inputs the image event information detected in the image event detection unit 112, for example, performs a target updating process using a particle filter, and generates target information and signal information based on the image event to thereby output the generated information to the processing determination unit 132. In addition, the target information as the updating result is output to the utterance source probability calculation unit 142.

The utterance source probability calculation unit 142 inputs the voice event information detected in the voice event detection unit 122, and calculates a probability in which each of targets is an utterance source of the input voice event using an ID model (identifier). The utterance source probability calculation unit 142 generates, based on the calculated value, signal information based on the voice event, and outputs the generated information to the processing determination unit 132.

First, a process performed by the target information updating unit 141 will be described.

The target information updating unit 141 of the information integration processing unit 131 performs a process of leaving only more probable hypothesis by setting probability distribution data of hypothesis with respect to a position and ID information of a user, and updating the hypothesis based on the input information. As this processing scheme, a process to which a particle filter is applied is performed.

The process to which the particle filter is applied is performed by setting a large number of particles corresponding to various hypotheses. In this embodiment, a large number of particles corresponding to hypotheses concerning a position of the user and who the user is are set, and a process of increasing a more probable weight of the particles based on three pieces of information shown in FIG. 3B from the image event detection unit 112, that is, (a) user position information, (b) user ID information (face ID information or utterer ID information), and (c) face attribute information (face attribute score) is performed.

A basic processing example to which the particle filter is applied will be described with reference to FIG. 4. For example, the example shown in FIG. 4 shows a processing example of estimating a presence position equivalent to any user by the particle filter. In the example shown in FIG. 4, a process of estimating a position where a user 301 is present in a one-dimensional area on any straight line is performed.

An initial hypothesis (H) becomes uniform particle distribution data as shown in FIG. 4A. Next, image data 302 is acquired, and probability distribution data of presence of a user 301 based on the acquired image is acquired as data of FIG. 4B. Based on the probability distribution data based on the acquired image, particle distribution data of FIG. 4A is updated, thereby obtaining updated hypothesis probability distribution data of FIG. 4C. This process is repeatedly performed based on the input information, thereby obtaining position information more probable than that of the user.

In addition, details of the process using the particle filter are described in, for example, <D. Schulz, D. Fox, and J. Hightower. People Tracking with Anonymous and ID-sensors Using Rao-Blackwellised Particle Filters. Proc. of the International Joint Conference on Artificial Intelligence (IJCAI-03)>.

In the processing example shown in FIG. 4, input information is processed only with respect to a presence position of the user only using the image data. Here, each of the particles has information concerning only the presence position of the user 301.

The target information updating unit 141 of the information integration processing unit 131 acquires information shown in FIG. 3B from the image event detection unit 112, that is, (a) user position information, (b) user ID information (face ID information or utterer ID information), and (c) face attribute information (face attribute score), and determines positions of a plurality of users and who each of the plurality of users is. Accordingly, in the process to which the particle filter is applied, the information integration processing unit 131 sets a large number of particles corresponding to hypothesis concerning a position of the user and who the user is, so that particle updating is performed based on two pieces of information shown in FIG. 3B in the image event detection unit 112.

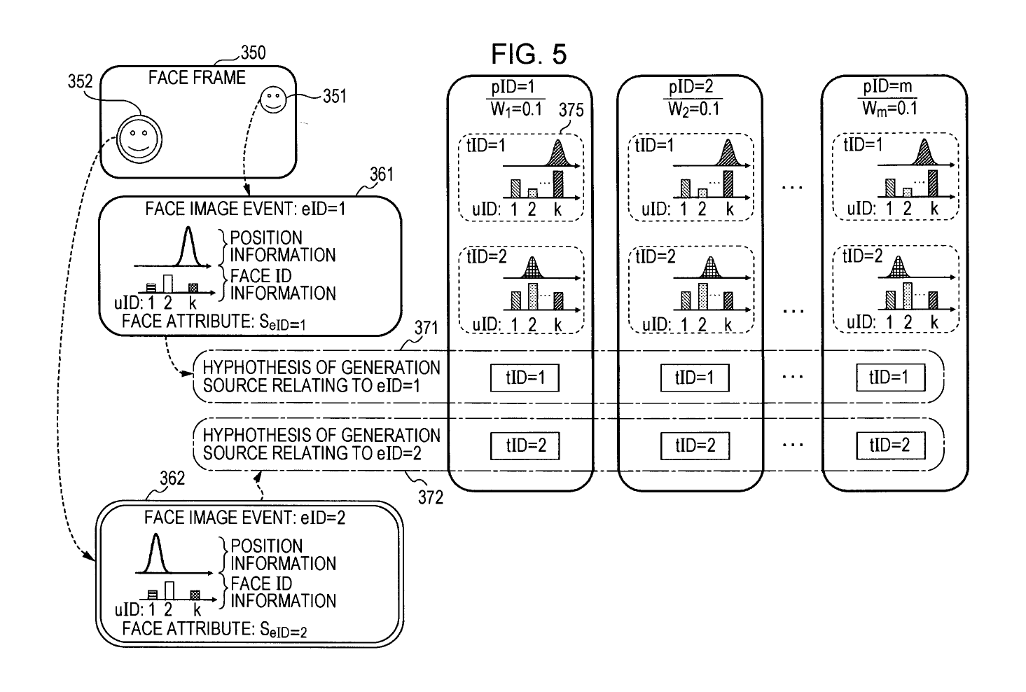

A particle updating processing example performed by inputting, by the information integration processing unit 131, three pieces of information shown in FIG. 3B, that is, (a) user position information, (b) user ID information (face ID information or utterer ID information), and (c) face attribute information (face attribute score) from the voice event detection unit 122 and the image event detection unit 112 will be described with reference to FIG. 5.

In addition, the particle updating process which will be described below will be described as a processing example performed only using image event information in the target information updating unit 141 of the information integration processing unit 131.

A configuration of the particles will be described. The target information updating unit 141 of the information integration processing unit 131 has a predetermined number=m of particles. The particle shown in FIG. 5 is 1 to m. In each of the particles, a particle ID (PID=1 to m) as an identifier is set.

In each of the particles, a plurality of targets tID=1, 2, . . . n corresponding to a virtual object is set. In this embodiment, a plurality (n-numbered) of targets equivalent to virtual users more than the number of people estimated to be present in a real space are set as each of the particles. Each of m number of particles maintains data by the number of the targets in a target unit. In an example shown in FIG. 5, n-number (n=2) of targets are included in a single particle.

The target information updating unit 141 of the information integration processing unit 131 inputs event information shown in FIG. 3B from the image event detection unit 112, that is, (a) user position information, (b) user ID information (face ID information or utterer ID information), and (c) face attribute information (face attribute score [S_{eID}]), and performs updating of m-number of particles (PID=1 to m).

Each of targets 1 to n included in each of the particles 1 to m that is set by the information integration processing unit 131 shown in FIG. 5 is able to be associated with each of the input event information (eID=1 to k) in advance, and updating of a selected target equivalent to the input event according to the association is performed. Specifically, for example, the face image detected in the image event detection unit 112 is subjected to the updating process as a separate event by associating a target with each of the face image events.

A specific updating process will be described. For example, the image event detection unit 112 generates (a) user position information, (b) user ID information, and (c) face attribute information (face attribute score) based on the image information input from the image input unit (camera) 111 at a certain frame interval determined in advance, and inputs the generated information to the information integration processing unit 131.

In this instance, when an image frame 350 shown in FIG. 5 is a frame of an event which is to be detected, an event equivalent to the number of face images included in the image frame. That is, an event 1(eID=1) equivalent to a first face image 351 shown in FIG. 5, and an event 2(eID=2) equivalent to a second face image 352 are detected.

The image event detection unit 112 generates (a) user position information, (b) user ID information, and (c) face attribute information (face attribute score) with respect to each of the events (eID=1, 2, . . . ), and inputs the generated information to the information integration processing unit 131. That is, the generated information is information 361 and 362 equivalent to the events shown in FIG. 5.

Each of the targets 1 to n included in each of the particles 1 to m set in the target information updating unit 141 of the information integration processing unit 131 is able to be associated with each event (eID=1 to k), and has a configuration in which updating which target included in each of the particles is set in advance. In addition, the association of the target (tID) equivalent to each of the events (eID=1 to k) is set not to be overlapped. That is, event generation source hypothesis is generated by an acquired event so that the overlap does not occur in each of the particles.

In an example shown in FIG. 5,

(1) particle 1(pID=1) is a corresponding target of [event ID=1(eID=1)]=[target ID=1(tID=1)], and a corresponding target of [event ID=2(eID=2)]=[target ID=2(tID=2)],

(2) particle 2(pID=2) is a corresponding target of [event ID=1(eID=1)]=[target ID=1(tID=1)], and a corresponding target of [event ID=2(eID=2)]=[target ID=2(tID=2)],

. . . .

(m) particle m(pID=m) is a corresponding target of [event ID=1(eID=1)]=[target ID=2(tID=2)], and a corresponding target of [event ID=2(eID=2)]=[target ID=1(tID=1)].

In this manner, each of the targets 1 to n included in each of the particles 1 to m set in the target information updating unit 141 of the information integration processing unit 131 is able to be associated in advance with each of the events (eID=1 to k), and has a configuration in which updating which target included in each of the particles according to each event ID is determined. For example, by event corresponding information 361 of [event ID=1(eID=1)] shown in FIG. 5, only data of target ID=1(tID=1) is selectively updated in a particle 1 (pID=1).

Similarly, by event corresponding information 361 of [event ID=1(eID=1)] shown in FIG. 5, only data of target ID=1(tID=1) is selectively updated even in a particle 2 (pID=2). In addition, by event corresponding information 361 of [event ID=1(eID=1)] shown in FIG. 5, only data of target ID=2(tID=2) is selectively updated in a particle m (pID=m).

Event generation source hypothesis data 371 and 372 shown in FIG. 5 is event generation source hypothesis data set in each of the particles, and an updating target equivalent to the event ID is determined depending on information concerning that the event generation source hypothesis data is set in each of the particles.

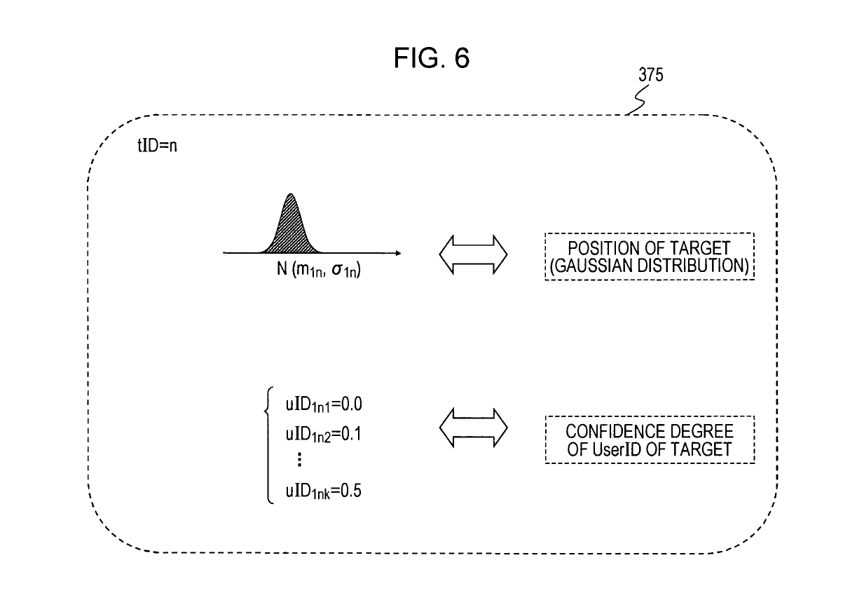

Each packet of target data included in each of the particles will be described with reference to FIG. 6. In FIG. 6, a configuration of target data of a single target 375 (target ID: tID=n) included in the particle 1 (pID=1) shown in FIG. 5 is shown. As shown in FIG. 6, the target data of the target 375 is configured by the following data, that is, (a) probability distribution of a presence position equivalent to each of the targets [Gaussian distribution: N(m₁ₙ,σ₁ₙ)], and (b) user confirmation degree information (uID) indicating who each of the targets is

uID₁ₙ₁=0.
uID₁ₙ₂=0.1
. . . .
uID₁ₙₖ=0.5.

In addition, (1ₙ) of [m₁ₙ,σ₁ₙ] in the Gaussian distribution: N(m₁ₙ,σ₁ₙ) shown in the above (a) signifies Gaussian distribution as presence probability distribution equivalent to target ID: tID=n in particle ID: pID=1.

In addition, (1n1) included in [uID₁ₙ₁] of the user confirmation degree information (uID) shown in the above (b) signifies a probability in which a user of target ID: tID=n in particle ID: PID=1 is user 1. That is, data of target ID=n signifies that a probability of being user 1 is 0.0, a probability of being user 2 is 0.1, . . . , and a probability of being user k is 0.5.

Referring again to FIG. 5, descriptions of the particles set in the target information updating unit 141 of the information integration processing unit 131 will be continuously made. As shown in FIG. 5, the target information updating unit 141 of the information integration processing unit 131 sets particles (PID=1 to m) of the predetermined number=m, and each of the particles has target data such as (a) probability distribution [Gaussian distribution: N(m,σ)] of a presence position equivalent to each of the targets, and (b) user confirmation degree information (uID) indicating who each of the targets is, with respect to each of targets (tID=1 to n) estimated to be present in a real space.

The target information updating unit 141 of the information integration processing unit 131 inputs event information (eID=1, 2 . . . ) shown in FIG. 3B, from the voice event detection unit 122 and the image event detection unit 112, that is, (a) user position information, (b) user ID information (face ID information or utterer ID information), and (c) face attribute information (face attribute score [S_{eID}]) r and performs updating of a target equivalent to an event set in advance in each of the particles.

In addition, a target to be updated is data included in each packet of target data, that is, (a) user position information, and (b) user ID information (face ID information or utterer ID information).

The (c) face attribute information (face attribute score [S_{eID}]) is finally used as signal information indicating an event generation source. When a certain number of events is input, the weighting of each particle is also updated, so that a weight of a particle having data closest to information in a real space is increased, and a weight of a particle having data unsuitable for the information in the real space is reduced. In this manner, when deviation occurs and converges in the weights of the particles, the signal information based on the face attribute information (face attribute score), that is, the signal information indicating the event generation source is calculated.

A probability in which any specific target x(tID=x) is a generation source of any event (eID=y) is represented as P_{eID=x}(tID=y). For example, as shown in FIG. 5, when m-number of particles (pID=1 to m) are set, and two targets (tID=1, 2) are set in each of the particles, a probability in which a first target (tID=1) is a generation source of a first event (eID=1) is P_{eID=}1(tID=1), and a probability in which a second target (tID=2) is a generation source of the first event (eID=1) is p_{eID=1}(tID=2).

In addition, a probability in which the first target (tID=1) is a generation source of a second event (eID=2) is P_{eID=2}(tID=1), and a probability in which the second target (tID=2) is the generation source of the second event (eID=2) is P_{eID=2}(tID=2).

The signal information indicating the event generation source is a probability P_{eID=x}(tID=y) in which a generation source of any event (eID=y) is a specific target x(tID=x), and this is equivalent to a ratio of the number of particles: m, which is set in the target information updating unit 141 of the information integration processing unit 131, and the number of targets allocated to each event. Here, in an example shown in FIG. 5, the following correspondence relationship is obtained:

P_{eID=1}(tID=1)=[the number of particles allocating tID=1 to a first event (eID=1)/(m)],
P_{eID=1}(tID=2)=[the number of particles allocating tID=2 to a first event (eID=1)/(m)],
P_{eID=2}(tID=1)=[the number of particles allocating tID=1 to second event (eID=2)/(m)], and
P_{eID=2}(tID=2)=[the number of particles allocating tID=2 to second event (eID=2)/(m)].

This data is finally used as the signal information indicating the event generation source.

In addition, a probability in which a generation source of any event (eID=y) is a specific target x(tID=x) is P_{eID=x}(tID=y). This data is applied to even calculation of the face attribute information included in the target information. That is, this data is used in calculating the face attribute information S_{tID=1 to n}. Face attribute information S_{tID=x} is equivalent to an expected value of a final face attribute of a target ID=x, that is, a value indicating a probability of being an utterer.

The target information updating unit 141 of the information integration processing unit 131 inputs event information (eID=1, 2 . . . ) from the image event detection unit 112, and performs updating of a target equivalent to an event set in advance in each of the particles. Next, the target information updating unit 141 generates (a) target information including position estimated information indicating a position of each of a plurality of users, estimated information (uID estimated information) indicating who each of the plurality of users is, and an expected value of face attribute information (S_{tID}), for example, a face attribute expected value indicating speaking with a moving mouth, and (b) signal information (image event correspondence signal information) indicating an event generation source such as a user uttering words, and outputs the generated information to the processing determination unit 132.

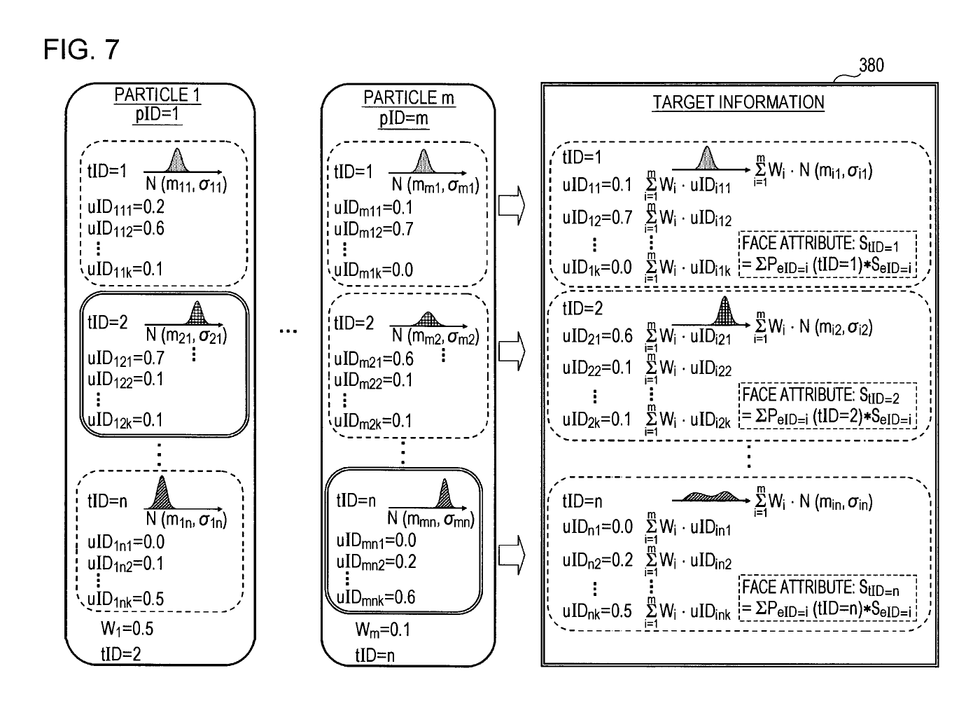

As shown in target information 380 shown in a right end portion of FIG. 7, the target information is generated as weighted sum data of correspondence data of each of targets (tID=1 to n) included in each of the particles (PID=1 to m). In FIG. 7, m-number of particles (pID=1 to m) of the information integration processing unit 131, and target information 380 generated from the m-number of particles (pID=1 to m) are shown. The weighting of each particle will be described later.

The target information 380 is information indicating (a) a presence position, (b) who the user is (from among users uID1 to uIDk), and (c) an expected value of face attribute (expected value (probability) of being an utterer in this embodiment) with respect to targets (tID=1 to n) equivalent to a virtual user set in advance by the information integration processing unit 131.

The (c) expected value of the face attribute of each of targets (expected value (probability) being an utterer in this embodiment) is calculated based on a probability P_{eID=x}(tID=y) equivalent to the signal information indicating the event generation source as described above, and a face attribute score S_{eID=i} equivalent to each of the events. Here, ‘i’ denotes an event ID.

For example, the expected value of the face attribute of the target ID=1: S_{tID=1} is calculated from the following Equation.

When S_{tID=1}=Σ_{eID}P_{eID=i}(tID=1)×S_{eID=1} is generalized and shown, the expected value of the face attribute of the target: S_{tID} is calculated from the following Equation.

S_{tID}=Σ_{eID}P_{eID=i}(tID)×S_{eID} <Equation 1>

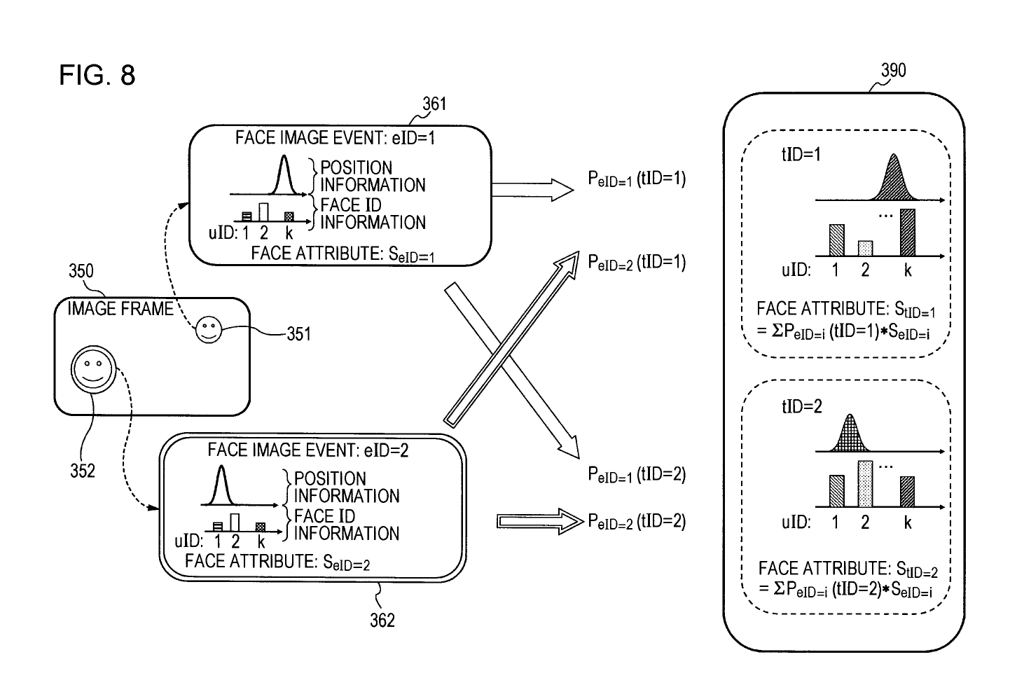

For example, as shown in FIG. 5, in a case where two targets are present within a system, a calculation example of an expected value of a face attribute of each of targets (tID=1, 2) when two face image events (eID=1, 2) is input to the information integration processing unit 131 from the image event detection unit 112 within a frame of an image 1 is shown in FIG. 8.

Data shown in a right end of FIG. 8 is target information 390 equivalent to target information 380 shown in FIG. 7, and is equivalent to information generated as weighted sum data of correspondence data of each of the targets (tID=1 to n) included in each of the particles (PID=1 to m).

A face attribute of each of the targets in the target information 390 is calculated based on a probability P_{eID=x}(tID=y) equivalent to the signal information indicating the event generation source as described above, and a face attribute score S_{eID=1} corresponding to each event. Here, “i” is an event ID.

An expected value of a face attribute of a target ID=1: S_{tID=1} is represented as S_{tID=1}=Σ_{eID}P_{eID=i}(tID=1)×S_{eID=i}, and an expected value of a face attribute of a target ID=2: S_{tID=2} is represented as S_{tID=2}=Σ_{eID}P_{eID=i}(tID=2)×S_{eID=i}. A sum of all targets of the expected value of the face attribute of each target: S_{tID} becomes [1]. In this embodiment, since expected values 1 to 0 of face attribute: S_{tID} is set with respect to each of the targets, a target having a high expected value is determined such that a probability of being an utterer is high.

In addition, when a face attribute score [S_{eID}] does not exist in the face image event eID (for example, when a movement of a mouth is not detected due to a hand covering the mouth even though a face is detected, a value Sₚᵣᵢₒᵣ of prior knowledge, or the like is used in the face attribute score S_{eID}. As the value of prior knowledge, when a value previously obtained is present for each target, the value is used, or an average value of the face attribute that is calculated from the face image event obtained in the off-line in advance is used.

The number of targets and the number of the face image events within the frame of the image 1 is not typically the same. Since a sum of probability P_{eID}(tID) equivalent to the signal information indicating the above described event generation source does not become [1] when the number of targets is larger than the number of the face image events, even a sum of expected values with respect to each of targets of the above described calculation equation of the expected value of the face attribute of each target, that is, S_{tID}=Σ_{eID}P_{eID=i}(tID)×S_{eID} (Equation 1) does not become [1], so that an expected value with high accuracy is not calculated.

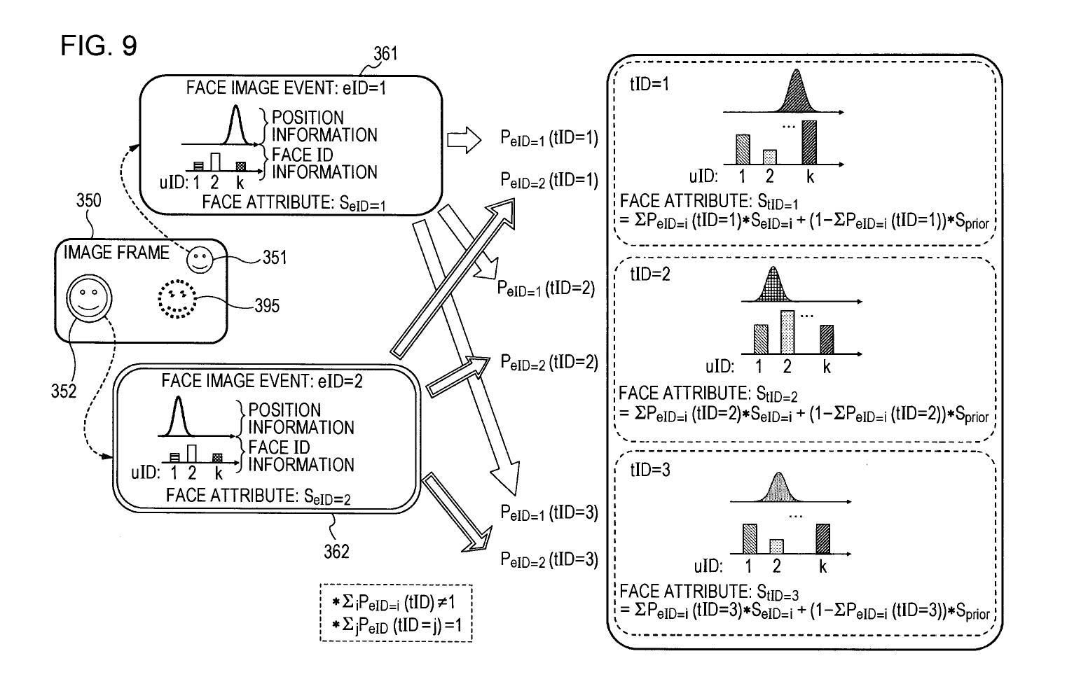

As shown in FIG. 9, when a third face image 395 equivalent to a third event present in a previous processing frame is not detected in the image frame 350, the sum of the expected values with respect to each of the targets shown in the above Equation 1 is not [1], and the expected value with high accuracy is not calculated. In this case, the expected value calculation equation of the face attribute of each target is changed. That is, so that the sum of the expected values S_{tID} of the face attribute of each target is [1], the expected value S_{tID} of the face event attribute is calculated in the following Equation 2 using a complement [1−Σ_{eID}P_{eID}(tID)] and the value prior [Sₚᵣᵢₒᵣ] knowledge.

S_{tID}=Σ_{eID}P_{eID}(tID)×S_{eID}+(1−Σ_{eID}P_{eID}(tID))×Sₚᵣᵢₒᵣ <Equation 2>

In FIG. 9, three targets equivalent to an event are set within a system, however, a calculation example of an expected value of face attribute when only two targets are input as the face image event within a frame of an image 1 from the image event detection unit 112 to the information integration processing unit 131 is illustrated.

The calculation is performed such that an expected value of face attribute of target ID=1: S_{tID=1} is S_{tID=1}=Σ_{eID}P_{eID=i}(tID=1)×S_{eID=1}+(1−Σ_{eID}P_{eID}(tID=1)×Sₚᵣᵢₒᵣ, an expected value of face attribute of target ID=2: S_{tID=2} is S_{tID=2}=Σ_{eID}P_{eID=i}(tID=2)×S_{eID=i}+(1−Σ_{eID}P_{eID}(tID=2)×Sₚᵣᵢₒᵣ, and an expected value of face attribute of target ID=3: S_{tID=3} is S_{tID=3}=Σ_{eID}P_{eID=i}(tID=3)×S_{eID=i}+(1−Σ_{eID}P_{eID}(tID=3)×Sₚᵣᵢₒᵣ.

Conversely, when the number of targets is smaller than the number of the face image events, the targets are generated so that the number of targets is the same as that of the events, and an expected value [S_{eID=1}] of the face attribute of each target is calculated by applying the above Equation 1.

In addition, the face attribute is described as the face attribute expected value based on a score equivalent to the movement of the mouth in this embodiment, that is, as data indicating an expected value in which each target is an utterer, however, the face attribute score, as described above, is able to be calculated as a score such as a smiling face or an age, and the face attribute expected value in this case is calculated as data equivalent to attribute equivalent to the score.

The target information is sequentially updated accompanying the updating of the particles, and, for example, when users 1 to k do not move within a real environment, each of the users 1 to k converges as data equivalent to each of k-number selected from n-number of targets tID=1 to n.

For example, user confirmation degree information (uID) included in data of a top target 1 (tID=1) within target information 380 shown in FIG. 7 has the highest probability with respect to a user 2 (uID₁₂=0.7). Accordingly, data of this target 1 (tID=1) is estimated to be equivalent to the user 2. In addition, 12 of uID₁₂ within data [uID₁₂=0.7] indicating user confirmation degree information uID is a probability of being equivalent to user confirmation degree information uID of user=2 of target ID=1.

In data of a top target 1 (tID=1) within this target information 380, a probability of being a user 2 is the highest, and the user 2 is estimated to be within a range shown in the presence probability distribution data in which a presence position of the user 2 is included in the data of the top target 1 (tID=1) of the target information 380.

In this manner, the target information 380 is information indicating (a) a presence position, (b) who the user is (from among users uID1 to uIDk), and (c) an expected value of face attributes (expected value (probability) of being an utterer in this embodiment), with respect to each of the targets (tID=1 to n) initially set as a virtual object (virtual user). Accordingly, each of k-number of target information of each of targets (tID=1 to n) converges to be equivalent to the users 1 to k when the user does not move.

As described above, the information integration processing unit 131 performs updating of the particles based on the input information, and generates (a) target information as estimated information concerning a position of a plurality of users, and who each of the plurality of users is, and (b) signal information indicating the event generation source such as a user uttering words to thereby output the generated information to the processing determination unit 132.

In this manner, the target information updating unit 141 of the information integration processing unit 131 performs particle filtering process to which a plurality of particles setting a plurality of target data corresponding to a virtual user is applied, and generates analysis information including position information of a user present in a real space. That is, each packet of target data set in particles is set to be associated with each event input from the event detection unit, and updating of target data corresponding to the event selected from each of the particles according to an input event identifier.

In addition, the target information updating unit 141 calculates an inter-event generation source hypothesis target likelihood set in each of the particles and the event information input from the event detection unit, and sets a value equivalent to the scale of the likelihood as a weight of the particle in each of the particles, so that a re-sampling process preferentially selecting a particle having a large weight is performed to update the particles. This process will be described later. In addition, with respect to the target set in each of the particles, updating over time is performed. In addition, according to the number of the event generation source hypothesis targets set in each of the particles, the signal information is generated as a probability value of the event generation source.

Meanwhile, the utterance source probability calculation unit 142 of the information integration processing unit 131 inputs the voice event information detected in the voice event detection unit 122, and calculates a probability in which each target is an utterance source of the input voice event using an ID model (identifier). The utterance source probability calculation unit 142 generates signal information concerning a voice event based on the calculated value, and outputs the generated information to the processing determination unit 132.

Details of the process performed by the utterance source probability calculation unit 142 will be described later.

<3. Processing Sequence Performed by the Information Processing Apparatus of the Present Disclosure>

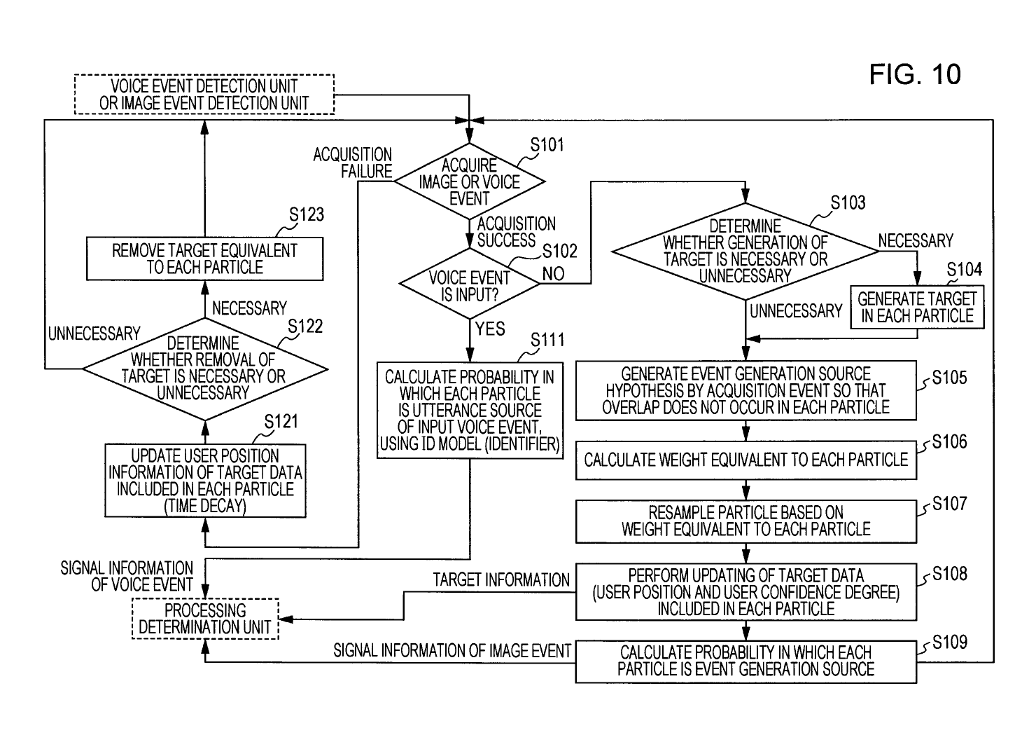

Next, a processing sequence performed by the information integration processing unit 131 will be described with reference to the flowchart shown in FIG. 10.

The information integration processing unit 131 inputs event information shown in FIG. 3B from the voice event detection unit 122 and the image event detection unit 112, that is, the user position information and the user ID information (face ID information or utterer ID information), generates (a) target information as estimated information concerning a position of a plurality of users, and who each of the plurality of users is, and (b) signal information indicating an event generation source of, for example, a user, or the like uttering words, and outputs the generated information to the processing determination unit 132. This processing sequence will be described with reference to the flowchart shown in FIG. 10.

First, in step S101, the information integration processing unit 131 inputs event information such as (a) user position information, (b) user ID information (face ID information or utterer ID information), and (c) face attribute information (face attribute score) from the voice event detection unit 122 and the image event detection unit 112.

When acquisition of the event information is successfully performed, the process proceeds to step S102, and when the acquisition of the event information is wrongly performed, the process proceeds to step S121. The process of step S121 will be described later.

When the acquisition of the event information is successfully performed, the information integration processing unit 131 determines whether a voice event is input in step S102. When the input event is the voice event, the process proceeds to step S111, and when the input event is an image event, the process proceeds to step S103.

When the input event is the voice event, in step S111, a probability in which each target is an utterance source of the input voice event is calculated using an ID model (identifier). The calculated result is output to the processing determination unit 132 (see FIG. 2) as the signal information based on the voice event. Details of step S111 will be described later.

When the input event is the image event, in step S103, updating of a particle based on the input information is performed, however, whether setting of a new target has to be performed with respect to each of the particles is determined in step S103 before performing the updating of the particle. In a configuration of the disclosure, each of targets 1 to n included in each of particles 1 to m set in the information integration processing unit 131 is able to be associated with each of the input event information (eID=1 to k), as described with reference to FIG. 5, and updating of the selected target equivalent to the input event is performed according to the association.

Accordingly, when the number of events input from the image event detection unit 112 is larger than the number of the targets, setting of a new target has to be performed. Specifically, this corresponds to a case in which a face that was not present until now appears in an image frame 350 shown in FIG. 5. In this case, the process proceeds to step S104, so that a new target is set in each particle. This target is set as a target updated to be equivalent with the new event.

Next, in step S105, hypothesis of an event generation source is set in each of m-number of particles (pID=1 to m) of particles 1 to m set in the information integration processing unit 131. As for the event generation source, for example, when the event generation source is the voice event, a user uttering words is the event generation source, and when the event generation source is the image event, a user having an extracted face is the event generation source.

A process of setting the hypothesis of the present disclosure is performed such that each of the input event information (eID=1 to k) is set to be associated with each of the targets 1 to n included in each of the particles 1 to m, as described with reference to FIG. 5.

That is, as described with reference to FIG. 5, each of the targets 1 to n included in each of the particles 1 to m is associated with each of the events information (eID=1 to k), and updating which target included in each of the particles is set in advance. In this manner, the event generation source hypothesis by the acquisition event is generated in each of the particles so that overlap does not occur. In addition, initially, for example, a setting in which each event is uniformly distributed may be used. Since the number of particles: m is set to be larger than the number of targets: n, a plurality of particles is set as particles having correspondence of the same event ID-target ID. For example, when the number of targets: n is 10, a process in which the number of particles: m=100 to 1000 is set is performed.

When the setting of the hypothesis is completed in step S105, the process proceeds to step S106. In step S106, a weight equivalent to each particle, that is, a particle weight [W_{pID}] is calculated. As for the particle weight [W_{pID}], a uniform value is initially set to each particle, however, updating is performed according to the event input.

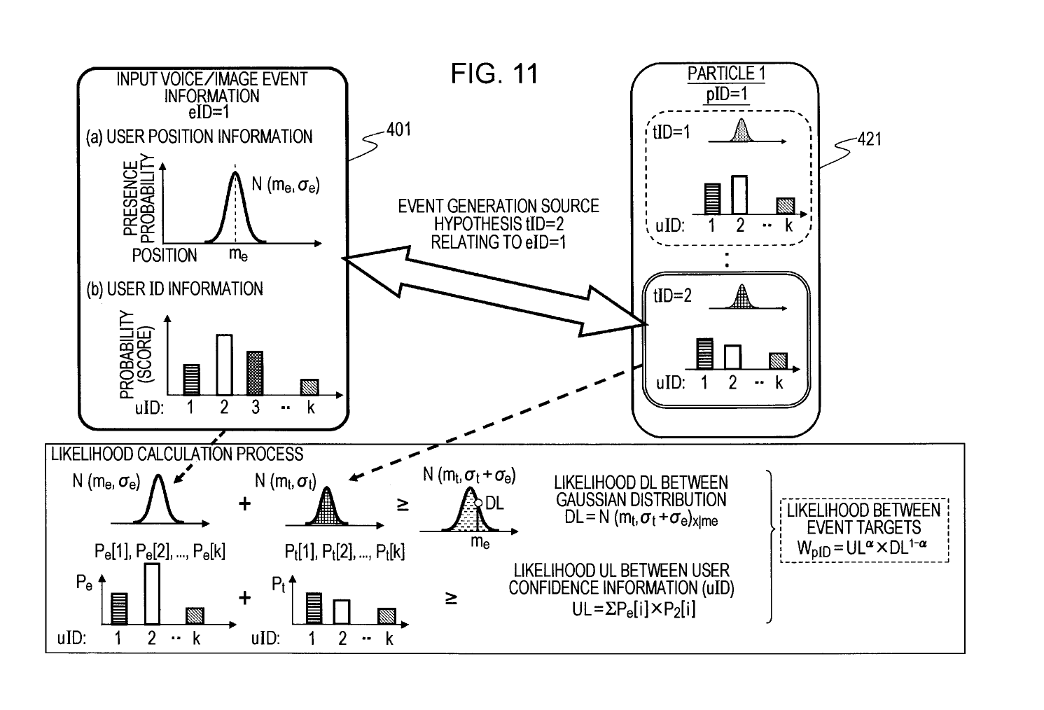

A calculation process of the particle weight [W_{pID}] will be described in detail with reference to FIG. 11. The particle weight [W_{pID}] corresponds to an index of correctness of hypothesis of each particle generating a hypothesis target of the event generation source. The particle weight [W_{pID}] is calculated as likelihood between the event and the target, that is, the similarity with the input event being the event generation source that is able to be associated with each of the plurality of targets set in each of the m-number of particles (pID=1 to m).

In FIG. 11, the information integration processing unit 131 shows event information 401 equivalent to a single event (eID=1) input from the voice event detection unit 122 and the image event detection unit 112, and a single particle 421 maintained by the information integration processing unit 131. A target (tID=2) of the particle 421 is a target being able to be associated with an event (eID=1).

In a lower end of FIG. 11, a calculation processing example of likelihood between the event and the target is shown. The particle weight [W_{pID}] is calculated as a value equivalent to a sum of likelihood between the event and the target as the similarity index between the event and the target calculated in each particle.

The process of calculating the likelihood shown in a lower end of FIG. 11 is performed such that (a) inter-Gaussian distribution likelihood [DL] as similarity data between an event with respect to user position information and target data, and (b) inter-user confirmation degree information (uID) likelihood [UL] as similarity data between an event with respect to user ID information (face ID information or utterer ID information) and target data are separately calculated.

A calculation process of the inter-Gaussian distribution likelihood [DL] as the similarity data between the (a) events with respect to the user position information and hypothesis target is the following process.

When Gaussian distribution equivalent to user position information within input event information is N(mₑ,σₑ), and Gaussian distribution equivalent to user position information of a hypothesis target selected from a particle is N(mₜ,σₜ), the inter-Gaussian distribution likelihood [DL] is calculated by the following equation.

DL=N(mₜ,σₜ+σₑ)x|mₑ

In the above equation, a value of a position of x=mₑ in the Gaussian distribution of distribution σₜ+σₑ in a center mₜ.

(b) The calculation process of the inter-user confirmation degree information (uID) likelihood [UL] as similarity data between an event for user ID information (face ID information or utterer ID information) and a hypothesis target is performed as below.

It is assumed that a value of confirmation degree each user 1 to k of user confirmation degree information (uID) within the input event information is Pe[i]. In addition, “i” is a variable equivalent to user identifiers 1 to k.

The inter-user confirmation degree information (uID) likelihood [UL] is calculated by the following equation using, as Pt[i], a value (score) of confirmation degree of each of the users 1 to k of the user confirmation degree information (uID) of the hypothesis target selected from the particle.

UL=ΣPe[i]×Pt[i]

In the above equation, a sum of products of values (score) of respective corresponding user confirmation degrees included in user confirmation degree information (uID) of two pieces of data is obtained, and the obtained sum is used as the inter-user confidence degree information (uID) likelihood [UL].

The particle weight [W_{pID}] is calculated by the following equation using a weight α (α=0 to 1) based on the above two likelihoods, that is, the inter-Gaussian distribution likelihood [DL] and the inter-user confirmation degree information (uID) likelihood [UL].

[W_{pID}]=ΣnULα×DL^{1-α}

Here, n denotes the number of targets equivalent to an event included in a particle. Using the above equation, the particle weight [W_{pID}] is calculated. However, a=0 to 1. The particle weight [W_{pID}] is calculated with respect to each of the particles.

The weight [α] applied to the calculation of the particle weight [W_{pID}] may be a predetermined fixed value, or a value changed according to an input event value. For example, when the input event is an image, face detection is successfully performed to acquire position information, however, when face ID is wrongly performed, the inter-user confirmation degree information (uID) likelihood: UL=1 is satisfied as a setting of α=0, so that the particle weight [W_{pID}] may be calculated depending on only the inter-Gaussian distribution likelihood [DL]. In addition, when the input event is a voice, utterer ID is successfully performed to acquire utterer information, however, when acquisition of the position information is wrongly performed, the inter-Gaussian distribution likelihood [DL]=1 is satisfied as a setting of α=0, so that the particle weight [W_{pID}] may be calculated depending on only the inter-user confirmation degree information (uID) likelihood [UL].

The calculation of the weight [W_{pID}] equivalent to each particle in step S106 of the flowchart of FIG. 10 is performed as the process described with reference to FIG. 11. Next, in step S107, a re-sampling process of the particle based on the particle weight [W_{pID}] of each particle set in step S106 is performed.

The re-sampling process of the particle is performed as a process of sorting out the particle according to the particle weight [W_{pID}] from m-number of particles. Specifically, for example, in a case of the number of particles: m=5, when the following particle weights are respectively set:

particle 1: particle weight [W_{pID}]=0.40,
particle 2: particle weight [W_{pID}]=0.10,
particle 3: particle weight [W_{pID}]=0.25,
particle 4: particle weight [W_{pID}]=0.05, and
particle 5: particle weight [W_{pID}]=0.20.

The particle 1 is re-sampled with 40% probability, and the particle 2 is re-sampled with 10% probability. In addition, in fact m=100 to 1,000, and the re-sampled result is configured by particles having a distribution ratio equivalent to the particle weight.

Through this process, more particles having large particle weight [W_{pID}] remain. In addition, even after the re-sampling, the total number of particles [m] is not changed. In addition, after the re-sampling, the weight [W_{pID}] of each particle is re-set, and the process is repeatedly performed according to input of a new event from step S101.

In step S108, updating of target data (user position and user confirmation degree) included in each particle is performed.

As described with reference to FIG. 7, each target is configured by data such as:

(a) user position: probability distribution of a presence position equivalent to each target [Gaussian distribution: N(mₜ,σₜ)],

(b) establishment value (score) of being users 1 to k: Pt[i](i=1 to k) as user confirmation degree: user confirmation degree information (uID) indicating who each target, that is,

$${uID}_{t 1} = Pt [ 1 ]$$

$${uID}_{t 2} = Pt [ 2 ]$$

$$⋮$$

$${uID}_{tk} = Pt [ k ] ,$$

and

(c) expected value of face attribute (expected value (probability) being an utterer in this embodiment).

The (c) expected value of face attribute (expected value (probability) being an utterer in this embodiment) is calculated based on a probability P_{eID=x}(tID=y) equivalent to the above described signal information indicating the event generation source and a face attribute score S_{eID=i} equivalent to each event. Here, “i” is an event ID. For example, an expected value of a face attribute of target ID=1: S_{tID=i} is calculated by the following equation.

S_{tID=1}=Σ_{eID}P_{eID=i}(tID=1)×S_{eID=i}.

When generalized and indicated, the expected value of face attribute of the target: S_{tID=i} is calculated by the following Equation 1.

S_{tID}=Σ_{eID}P_{eID=i}(tID)×S_{eID} <Equation 1>

In addition, when the number of targets is larger than the number of face image events, such that a sum of expected values [S_{tID}] of face attribute of each target is [1], the expected value S_{tID} of the face event attribute is calculated in the following equation 2 using a complement [1−Σ_{eID}P_{eID}(tID)] and the value prior [Sₚᵣᵢₒᵣ] knowledge.

S_{tID}=Σ_{eID}P_{eID}(tID)×S_{eID}+(1−Σ_{eID}P_{eID}(tID))×Sₚᵣᵢₒᵣ <Equation 2>

The updating of the target data in step S108 is performed with respect to each of (a) user position, (b) user confirmation degree, and (c) expected value of face attribute (expected value (probability) being an utterer in this embodiment). First, the updating of (a) user position will be described.

The updating of (a) user position is performed as updating of the following two stages such as (a1) updating with respect to all targets of all particles, and (a2) updating with respect to event generation source hypothesis target set in each particle.

The (a1) updating with respect to all targets of all particles is performed with respect to targets selected as the event generation source hypothesis target and other targets. This updating is performed based on the assumption that dispersion of the user position is expanded over time, and the updating is performed, using the Kalman filter, by the elapsed time and the position information of the event from the previous updating process.

Hereinafter, an updating processing example in a case in which the position information is a one-dimension will be described. First, when the elapsed time after the time of the previous updating process is [dt], prediction distribution of the user position after dt is calculated with respect to all targets. That is, the following updating is performed with respect to Gaussian distribution as distribution information of the user position: expected value (average) of N (mₜ,σₜ): [mₜ], and distribution [σₜ].

mₜ=mₜ+xc×dt

σₜ²=σₜ²+σc²×dt

Here, mₜ denotes a predicted expectation value (predicted state), σₜ² denotes a predicted covariance (predicted estimation covariance), xc denotes movement information (control model), and σc² denotes noise (process noise).

In addition, in a case of performing the updating under a condition where the user does not move, the updating is performed using xc=0.

By the above calculation process, Gaussian distribution: N(mₜ,σₜ) as the user position information included in all targets is updated.

Next, the (a2) updating with respect to event generation source hypothesis target set in each particle will be described.

In step S104, a target selected according to the set event generation source hypothesis is updated. First, as described with reference to FIG. 5, each of the targets 1 to n included in each of the particles 1 to m are set as targets being able to be associated with each of the events (eID=1 to k).

That is, which target included in each of the particles is updated according to the event ID (eID) is set in advance, and only targets being able to be associated with the input event are updated based on the setting. For example, by event correspondence information 361 of [event ID=1(eID=1)] shown in FIG. 5, only data of the target ID=1(tID=1) is selectively updated in the particle 1 (pID=1).

In the updating process performed based on the event generation source hypothesis, the updating of the target being able to be associated with the event is performed. The updating process using Gaussian distribution: N(mₑ,σₑ) indicating the user position included in the event information input from the voice event detection unit 122 or the image event detection unit 112 is performed.

For example, when it is assumed that K denotes Kalman Gain, mₑ denotes an observed value (observed state) included in input event information: N(mₑ,σₑ), and σₑ² denotes an observed value (observed covariance) included in the input event information: N(mₑ,σₑ), the following updating is performed:

K=σₜ²/(σₜ²+σₑ²),

mₜ=mₜ+K(xc−mₜ),

and

σₜ²=(1−K)σₜ².

Next, the (b) updating of the user confirmation degree performed as the updating process of the target data will be described. In the target data, a probability (score) being each user 1 to k: Pt[i](i=1 to k) as the user confirmation degree information (uID) indicating who each target is, other than the user position information is included. In step S108, an updating process with respect to the user confirmation degree information (uID) is performed.

The updating with respect to the user confirmation degree information (uID) of the target included in each particle: Pt[i](i=1 to k) is performed by a posterior probability of all of the registered users, and the user confirmation degree information (uID): Pt[i](i=1 to k) included in the event information input from the voice event detection unit 122 or the image event detection unit 112, by applying an update rate [β] having a value of a range of 0 to 1 set in advance.

The updating with respect to the user confirmation degree information (uID) of the target: Pt[i](i=1 to k) is performed by the following equation.

Pt[i]=(1−β)×Pt[i]+β*Pe[i]

Here, i=1 to k, and β=0 to 1. In addition, the update rate [β] corresponds to a value of 0 to 1, and is set in advance.

In step S108, the following data included in the updated target data, that is, (a) user position: probability distribution of presence position equivalent to each target [Gaussian distribution: N(mₜ,σₜ)], (b) establish value (score) being each user 1 to k: Pt[i](i=1 to k) as user confirmation degree: user confirmation degree information (uID) indicating who each target is, that is,

$${uID}_{t 1} = Pt [ 1 ]$$

$${uID}_{t 2} = Pt [ 2 ]$$

$$⋮$$

$${uID}_{tk} = Pt [ k ] ,$$

and (c) expected value of face attribute (expected value (probability) being an utterer in this embodiment).

The target information is generated based on the above described data and each particle weight [W_{pID}], and outputs the generated target information to the processing determination unit 132.

In addition, the target information is generated as weighted sum data of correspondence data of each of targets (tID=1 to n) included in each of the particles (PID=1 to m). The target information is data shown in the target information 380 shown in a right end of FIG. 7. The target information is generated as information including (a) user position information, (b) user confirmation degree information, and (c) expected value of face attribute (expected value (probability) being an utterer in this embodiment) of each of the targets (tID=1 to n).

For example, user position information of the target information equivalent to the target (tID=1) is represented as the following Equation A.

$${\sum }_{i = 1}^{m} {W}_{i} \cdot N ( {m}_{i 1} , {σ}_{ i 1} ) \qquad ( Equation A )$$

In the above Equation 1, W₁ denotes a particle weight [W_{pID}].

In addition, user confirmation degree information of the target information equivalent to the target (tID=1) is represented as the following Equation B.

$${\sum }_{i = 1}^{m} {W}_{i} \cdot u {ID}_{i 11} \\ {\sum }_{i = 1}^{m} {W}_{i} \cdot {uID}_{i 12} \\ ⋮ \\ {\sum }_{i = 1}^{m} {W}_{i} \cdot {uID}_{i 1 k} \qquad ( Equation B )$$

In the above Equation B, Wᵢ denotes a particle weight [W_{pID}].

In addition, an expected value (expected value (probability) being an utterer in this embodiment) of face attribute of the target information equivalent to the target (tID=1) is represented as S_{tID=1}=Σ_{eID}P_{eID=i}(tID=1)×S_{eID=i} or S_{tID=1}=Σ_{eID}P_{eID=i}(tID=1)×S_{eID=i}+(1−Σ_{eID}P_{eID}(tID=1)×Sₚᵣᵢₒᵣ.

The information integration processing unit 131 calculates the above described target information with respect to each of n-number of targets (tID=1 to n), and outputs the calculated target information to the processing determination unit 132.

Next, a process of step S109 shown in the flowchart of FIG. 8 will be described. In step S109, the information integration processing unit 131 calculates a probability in which each of n-number of targets (tID=1 to n) is a generation source of the event, and outputs the calculated probability as the signal information to the processing determination unit 132.

As described above, the signal information indicating the event generation source is data indicating who utters words, that is, data indicating an utterer with respect to the voice event, and is data indicating who a face included in an image belongs to and data indicating the utterer with respect to the image event.

The information integration processing unit 131 calculates a probability in which each target is the event generation source, based on the number of hypothesis targets of the event generation source set in each particle. That is, the probability in which each of targets (tID=1 to n) is the event generation source is represented as [P(tID=i)]. Here, i=1 to n. For example, a probability in which a generation source of any event (eID=y) is a specific target x(tID=x) is represented as P_{eID=x}(tID=y) as described above, and is equivalent to a ratio between the number of particles set in the information integration processing unit 131: m and the number of targets allocated to each event. For example, in the example shown in FIG. 5, the following correspondence relationship is obtained:

P_{eID=1}(tID=1)=[the number of particles allocating tID=1 to a first event (eID=1)/(m)],

P_{eID}=₁(tID=2)=[the number of particles allocating tID=2 to a first event (eID=1)/(m)],

P_{eID}=₂(tID=1)=[the number of particles allocating tID=1 to second event (eID=2)/(m)], and

P_{eID}=₂(tID=2)=[the number of particles allocating tID=2 to second event (eID=2)/(m)].

This data is output to the processing determination unit 132 as the signal information indicating the event generation source.

When the process of step S109 is completed, the process returns to step S101 to thereby proceed to a waiting state for input of the event information from the voice event detection unit 122 and the image event detection unit 112.

As above, the descriptions of steps S101 to S109 shown in FIG. 10 have been made. When the information integration processing unit 131 does not acquire the event information shown in FIG. 3B from the voice event detection unit 122 and the image event detection unit 112 in step S101, updating of configuration data of the target included in each of the particles is performed in step S121. This updating is a process considering a change in the user position over time.

The updating of the target is the same process as the (a1) updating with respect to all targets of all particles described in step S108, is performed based on the assumption that dispersion of the user position is expanded over time, and is performed, using the Kalman filter, by the elapsed time and the position information of the event from the previous updating process.

Hereinafter, an updating processing example in a case in which the position information is a one-dimension will be described. First, the predicted calculation of the user position after dt is calculated with the elapsed time [dt] from the previous updating process for all targets. That is, the following updating is performed with respect to Gaussian distribution as distribution information of the user position: expected value (average) of N (mₜ,σₜ): [mₜ], and distribution [σₜ].

mₜ=mₜ+xc×dt

σₜ²=σₜ²+σc²×dt

Here, mₜ denotes a predicted expectation value (predicted state), σₜ² denotes a predicted covariance (predicted estimation covariance), xc denotes movement information (control model), and σc² denotes noise (process noise).

In addition, in a case of performing the updating under a condition where the user does not move, the updating is performed using xc=0.

By the above calculation process, Gaussian distribution: N(mₜ,σₜ) as the user position information included in all targets is updated.

In addition, unless a posterior probability of all of the registered users of the event or a score [Pe] from the event information is acquired, the updating with respect to the user confirmation degree information (uID) included in a target of each particle is not performed.

After the process of step S121 is completed, whether elimination of the target is necessary or unnecessary is determined in step 122, and when the elimination of the target is necessary, the target is eliminated in step S123. The elimination of the target is performed as a process of eliminating data in which a specific user position is not obtained, such as a case in which a peak is not detected in the user position information included in the target, and the like. When the above described data is absent, steps S122 to S123 in which the elimination is unnecessary are performed, and then the process returns to step S101 to thereby proceed to a waiting state for input of the event information from the voice event detection unit 122 and the image event detection unit 112.

As above, the process performed by the information integration processing unit 131 has been described with reference to FIG. 10. The information integration processing unit 131 repeatedly performs the process based on the flowchart shown in FIG. 10 for each input of the event information from the voice event detection unit 122 and the image event detection unit 112. By this repeatedly performed process, a weight of the particle in which more reliable target is set as a hypothesis target is increased, and particles with larger weights remain through the re-sampling process based on the particle weight. Consequently, highly reliable data similar to the event information input from the voice event detection unit 122 and the image event detection unit 112 remains, so that the following highly reliable information, that is, (a) target information as estimated information indicating a position of each of a plurality of users, and who each of the plurality of users is, and, for example, (b) signal information indicating the event generation source such as the user uttering words are ultimately generated, and the generated information is output to the processing determination unit 132.

In addition, in the signal information, two pieces of signal information such as (b1) signal information based on a voice event generated by the process of step S111, and (b2) signal information based on an image event generated by the process of steps S103 to 109 are included.

<4. Details of a Process Performed by Utterance Source Probability Calculation Unit>

Next, a process of step S111 shown in the flowchart of FIG. 10, that is, a process of generating signal information based on a voice event will be described in detail.

As described above, the information integration processing unit 131 shown in FIG. 2 includes the target information updating unit 141 and the utterance source probability calculation unit 142.

The target information updated for each the image event information in the target information updating unit 141 is output to the utterance source probability calculation unit 142.

The utterance source probability calculation unit 142 generates the signal information based on the voice event by applying the voice event information input from the voice event detection unit 122 and the target information updated for each the image event information in the target information updating unit 141. That is, the above described signal information is the signal information indicating how much each target resembles an utterance source of the voice event information, as the utterance source probability.

When the voice event information is input, the utterance source probability calculation unit 142 calculates the utterance source probability indicating how much each target resembles the utterance source of the voice event information using the target information input from the target information updating unit 141.

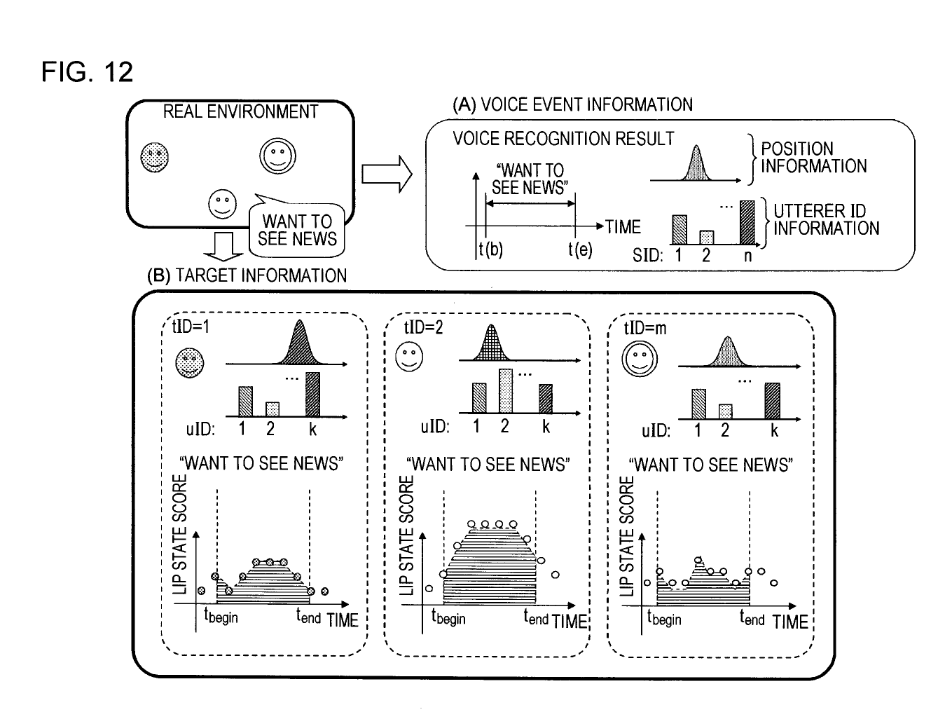

In FIG. 12, an example of input information such as (A) voice event information, and (B) target information which are input to the utterance source probability calculation unit 142 is shown.

The (A) voice event information is voice event information input from the voice event detection unit 122.

The (B) target information is target information updated for each image event information in the target information updating unit 141.

In the calculation of the utterance source probability, sound source direction information (position information) or utterer ID information included in the voice event information shown in (A) of FIG. 12, lip movement information included in the image event information, or target position n or the total number of targets included in the target information are used.

In addition, the lip movement information originally included in the image event information is supplied to the utterance source probability calculation unit 142 from the target information updating unit 141, as one piece of the face attribute information included in the target information.

In addition, the lip movement information in this embodiment is generated from a lip state score obtainable by applying the visual speech detection technique. In addition, the visual speech detection technique is described in, for example, [Visual lip activity detection and speaker detection using mouth region intensities/IEEE Transactions on Circuits and Systems for Video Technology, Volume 19, Issue 1 (January 2009), Pages: 133-137(see, URL: http://poseidon.csd.auth.gr/papers/PUBLISHED/JOURNAL/pdf/Sia tras09a)], [Facilitating Speech Detection in Style!: The Effect of Visual Speaking Style on the Detection of Speech in Noise Auditory-Visual Speech Processing 2005 (see, URL: http://www.isca-speech.org/archive/aysp05/av05_{—}023.html)], and the like, and this technique may be applicable.

An overview of generation method of lip movement information will be as follows.

The input voice event information is equivalent to any time interval Δt, so that a plurality of lip state scores included in a time interval Δt=(t_end to t_begin) are sequentially arranged to obtain time series data. An area of a region including this time series data is used as lip movement information.

A graph of the time/lip state score shown in the bottom of the target information of (B) of FIG. 12 corresponds to the lip movement information.

In addition, the lip movement information is regularized with a sum of the lip movement information of all targets.

As shown in FIG. 12, the utterance source probability calculation unit 142 acquires (a) user position information

(sound source direction information), and (b) user ID information (utterer ID information) which are equivalent to uttering as the voice event information input from the voice event detection unit 122.

In addition, the utterance source probability calculation unit 142 acquires information such as (a) user position information, (b) user ID information, and (c) lip movement information, as the target information updated for each the image event information in the target information updating unit 141.

In addition, even information such as the target position or the total number of targets that is included in the target information is input.

The utterance source probability calculation unit 142 generates a probability (signal information) in which each target is an utterance source based on the above described information, and outputs the generated probability to the processing determination unit 132.

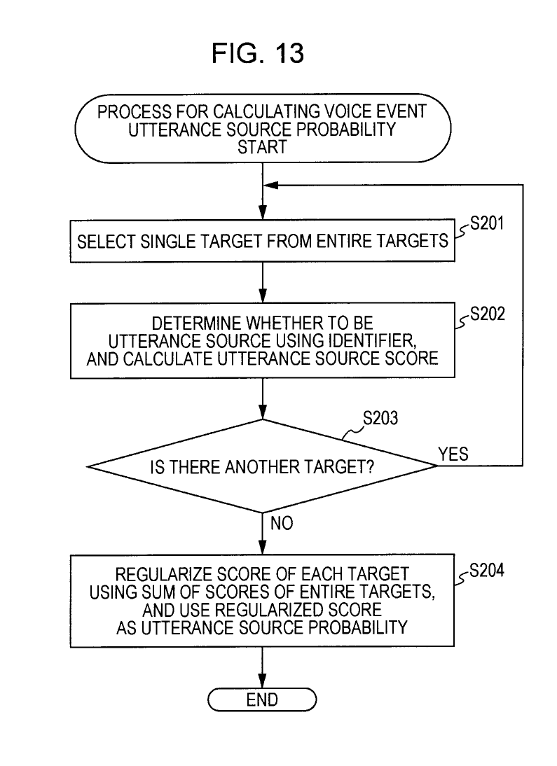

An example of a sequence of method of calculating the utterance source probability for each target that is performed by the utterance source probability calculation unit 142 will be described with reference to the flowchart shown in FIG. 13.

The processing example shown in the flowchart of FIG. 13 is a processing example using an identifier in which targets are individually selected, and an utterance source probability (utterance source score) indicating whether the target is a generation source is determined from only information of the selected target.

First, in step S201, a single target acting as a target to be processed is selected from all targets.

Next, in step S202, an utterance source score is obtained as a value of a probability whether the selected target is the utterance source using the identifier of the utterance source probability calculation unit 142.

The identifier is an identifier for calculating the utterance source probability for each target, based on input information such as (a) user position information (sound source direction information) and (b) user ID information (utterer ID information) input from the voice event detection unit 122, and (a) user position information, (b) user ID information, (c) lip movement information, and (d) target position or the number of targets input from the target information updating unit 141.

In addition, the input information of the identifier may be all of the above described information, however, only some pieces of the input information may be used.

In step S202, the identifier calculates the utterance source score as the probability value indicating whether the selected target is the utterance source.

In step S203, whether other unprocessed targets are present is determined, and when the other unprocessed targets are present, processes after step S201 are performed with respect to the other unprocessed targets.

In step S203, when the other unprocessed targets are absent, the process proceeds to step S204.

In step S204, the utterance source score obtained for each target is regularized with a sum of the utterance source scores of all of the targets to thereby determine the utterance source score as the utterance source probability that is equivalent to each target.

A target with the highest utterance source score is estimated to be the utterance source.

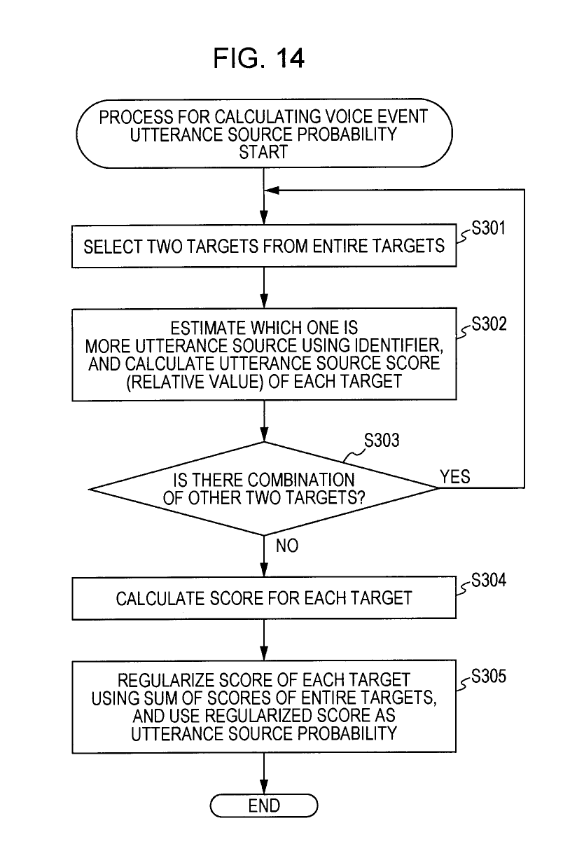

Next, another example of the sequence of the method for calculating the utterance source probability for each target will be described with reference to the flowchart of FIG. 14.

In a processing example shown in the flowchart of FIG. 14, a set of two targets is selected, and the identifier for determining a higher probability which target of the selected target pair is the utterance source is used.

In step S301, arbitrary two targets are sequentially selected from all of the targets.

Next, in step S302, which one of the selected two targets is the utterance source is determined using the identifier of the utterance source probability calculation unit 142, and applies, to each of the two targets, an utterance source score (relative value in a single set) with respect to the determination based on the determination result.

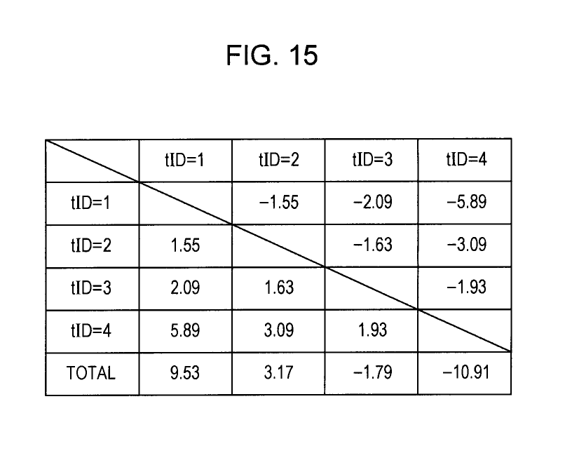

In FIG. 15, an example of the utterance source score applied to all of combination of arbitrary two targets is shown.

The example shown in FIG. 15 is obtained in a case in which the total number of targets is 4, and each of the targets satisfies tID=1 to 4.

Scores with respect to each of tID=1 to 4 is set in vertical column of Table shown in FIG. 15, and the total of the scores (total) is shown in the bottom.

For example, as for an utterance source score with respect to tID=1, a calculation score in a combination of tID=1 and tID=2 is 1.55, a calculation score in a combination of tID=1 and tID=3 is 2.09, and a calculation score in a combination of tID=1 and tID=4 is 5.89. Here, the total score is 9.53.

As for an utterance source score with respect to tID=2, a calculation score in a combination of tID=2 and tID=1 is −1.55, a calculation score in a combination of tID=2 and tID=3 is 1.63, and a calculation score in a combination of tID=2 and tID=4 is 3.09. Here, the total score is 3.17.

As for an utterance source score with respect to tID=3, a calculation score in a combination of tID=3 and tID=1 is −2.09, a calculation score in a combination of tID=3 and tID=2 is −1.63, and a calculation score in a combination of tID=3 and tID=4 is 1.93. Here, the total score is −1.79.

As for an utterance score with respect to tID=4, a calculation score in a combination of tID=4 and tID=1 is −5.89, a calculation score in a combination of tID=4 and tID=2 is −3.09, and a calculation score in a combination of tID=4 and tID=3 is −1.93. Here, the total score is −10.91.

A probability of being the utterance source becomes higher with an increase in the score, and the probability becomes lower with a reduction in the score.

In step S303, whether other unprocessed targets are present is determined, and when the other unprocessed targets are present, processes after step S301 are performed with respect to the other unprocessed targets.

In step 303, when the other unprocessed targets are determined to be absent, the process proceeds to step S304.

In step S304, the utterance source scores (relative value within the entire) for each target constituting all targets is calculated using the utterance source score (relative value in the set 1) obtained for each target.

In addition, in step S305, the utterance source scores (relative value within the entire) for each target calculated in step S304 are regularized with a sum of the utterance source scores of all of the targets, and the utterance score is determined as the utterance source probability equivalent to each target.

These final determination scores are equivalent to, for example, a sum of values shown in the bottoms of FIG. 15. In the example shown in FIG. 15, a score of a target tID=1 is 9.53, a score of a target tID=2 is 3.17, a score of a target tID=3 is −1.79, and a score of a target tID=4 is −10.91.

In addition, as the input information to the identifier for determining which one of the two targets described in this embodiment resembles the utterance source, a logarithmic likelihood ratio relating to the sound source direction information, the utterer ID information, or the lip movement information between the two targets to be determined may be used, other than the input information (sound source direction information or utterer ID information included in the voice event information, or lip movement information obtained from the lip state score, a target information, or the number of targets included in the target information) used for the identifier for determining whether the corresponding target is the utterance source.

Advantages using the logarithmic likelihood ratio of the above described information will be described.

It is assumed that the two targets being a determination target of the utterance source are T₁ and T₂.

Sound source direction information (D), utterer ID information (S), and lip movement information (L) of the above described two targets are shown as follows:

sound source direction information of target T₁=D₁,
utterer ID information of target T₁=S₁,
lip movement information of target T₁=L₁,
sound source direction information of target T₂=D₂,
utterer ID information of target T₂=S₂, and
lip movement information of target T₂=L₂.

In this instance, when a target equivalent to an actual utterer is T₁, the following inequation (C) is obtain with respect to the target T₂ other than the target T₁.

D₁^{α}·S₁^{β}·L₁>D₂^{α}·S₂^{β}·L₂ (Inequation C)

α log(D₁/D₂)+β log(S₁/S₂)+log(L₁/L₂)>0 (Inequation D)

α, β<0 log(D₁/D₂), log(S₁/S₂), log(L₁/L₂) (Inequation E)

Here, inequation C may be modified as inequation D.

In addition, when it is assumed that a weight coefficient α or β in inequation D is a positive number, a logarithmic likelihood ratio of each piece of information between two targets may be a positive number so as to obtain inequation D, basically similar to inequation E.

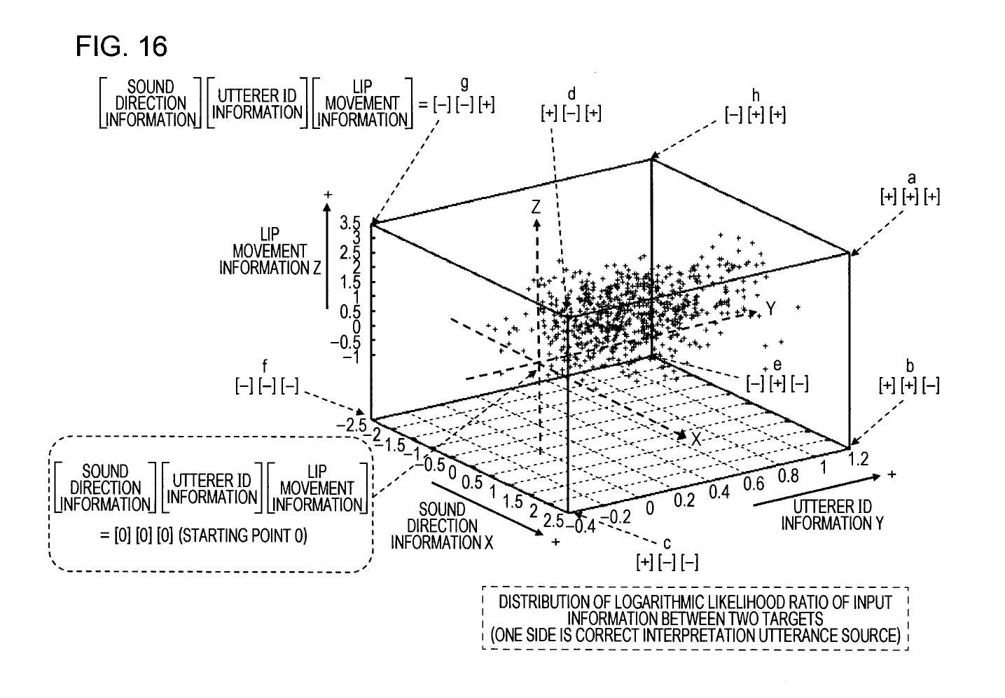

In FIG. 16, when it is assumed that two targets being a determination target of the utterance source are T₁ and T₂, in between two targets in which one of the two targets is a correct result utterance source, a logarithmic likelihood ratio of sound source direction information (D), the utterer ID information (S), and the lip movement information (L) which are input information is shown, and distribution data such as log(D₁/D₂), log(S₁/S₂), and log(L₁/L₂) is shown.

The number of measured samples is 400 utterances.

In the figure of FIG. 16, an X-axis, a Y-axis, and a Z-axis correspond to the sound source direction information (D), the utterer ID information (S), and the lip movement information (L), respectively.

As seen from the figure, many utterances are distributed in a region of positive values of each dimension.

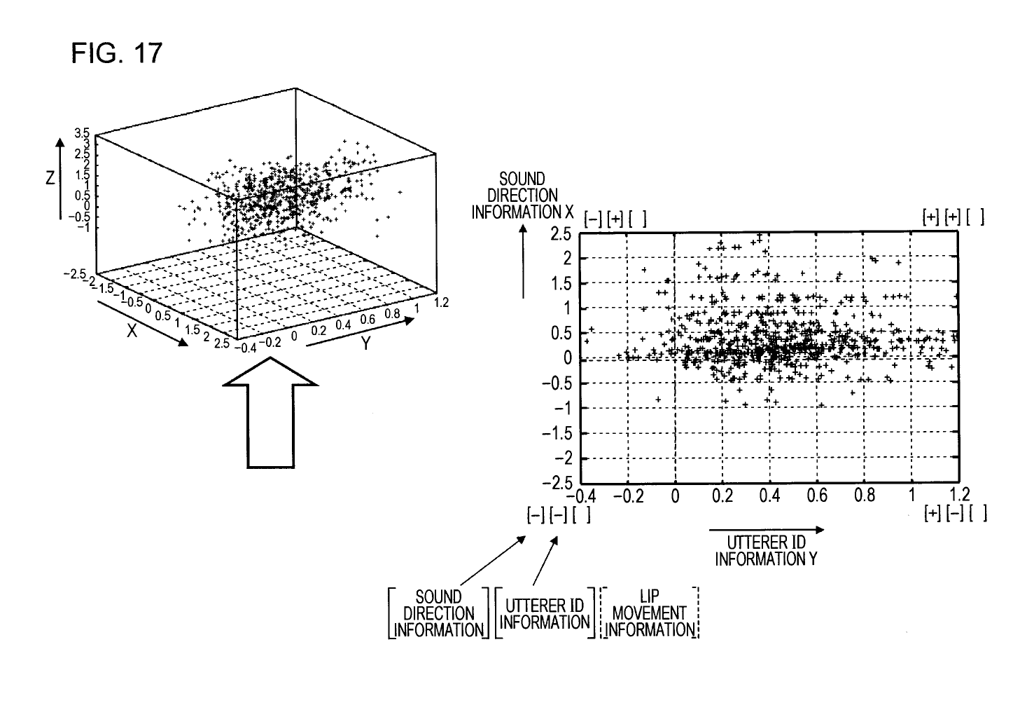

In the figure shown in FIG. 16, since three-dimensional information of XYZ is shown, it is difficult to recognize a position of a measured point. Thus, two-dimensional plane is shown in FIG. 17 to FIG. 19.

In FIG. 17, an XY plane shows two-axis distribution data of the sound source direction information (D) and the utterer ID information (S).

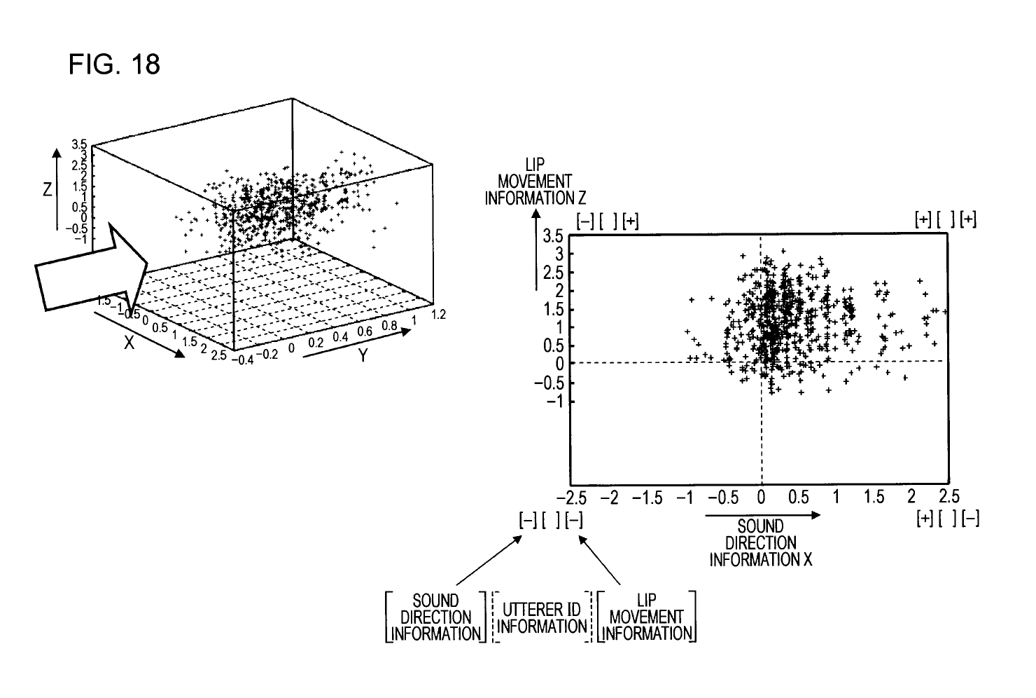

In FIG. 18, an XZ plane shows two-axis distribution data of the sound source direction information (D) and the lip movement information (L).

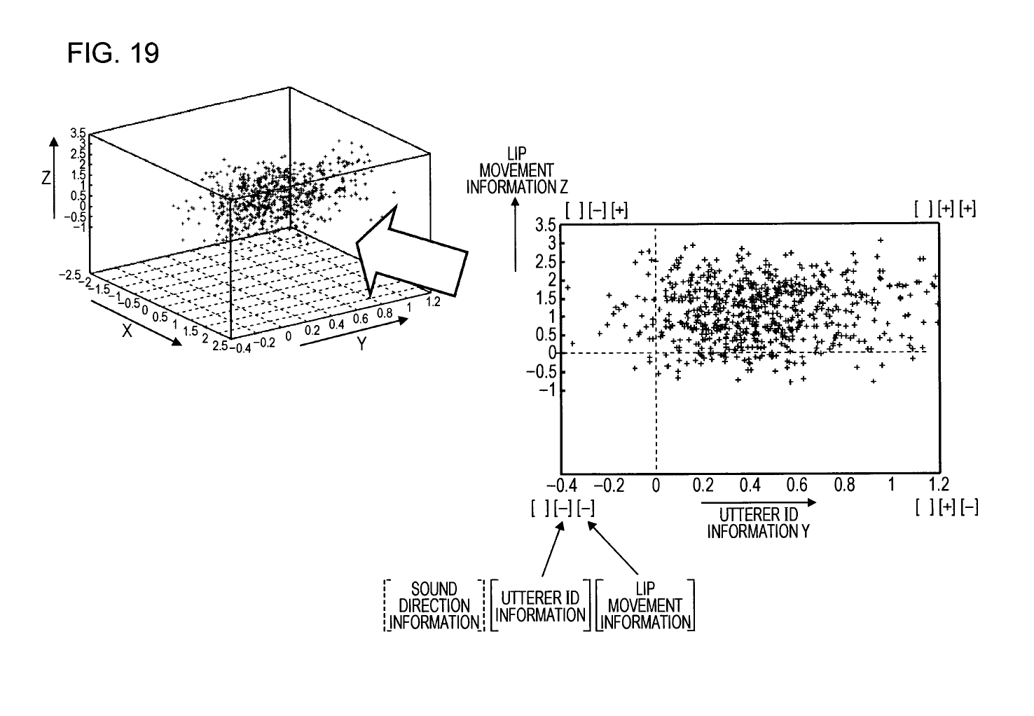

In FIG. 19, a YZ plane shows two-axis distribution data of the utterer ID information (S) and the lip movement information (L).

As seen from these figures, many utterances are distributed in a region of positive values of each dimension.

As described above, the two targets T₁ and T₂ being the determination target of the utterance source acquire input information such as the sound source direction information (D), the utterer ID information (S), and the lip movement information (L), so that it is possible to determine the utterance source with high accuracy based on the logarithmic likelihood ratio of the above described input information such as log(D₁/D₂), log(S₁/S₂), and log(L₁/L₂).

Accordingly, the determination by the identifier using the above described input information is performed, so that likelihood of each of the input information is regularized between the two targets, thereby performing more appropriate identification.

In addition, the identifier of the utterance source probability calculation unit 142 performs a process of calculating the utterance source probability (signal information) of each target according to the input information with respect to the identifier, however, as this algorithm, for example, boosting algorithm is applicable.

In a case in which the boosting algorithm is used in the identifier, a calculation equation of the utterance source score and an example of input information in the equation are shown as follows:

$$\begin{matrix}F ( X ) = {\sum }_{t = 1}^{T} {α}_{t} \cdot {f}_{t} ( X ) & ( Equation F ) \\ X = ( {D}_{1} , {S}_{1} , {L}_{1} ) & ( Equation G ) \\ X = ( {log ( {D}_{1} / D )}_{2} , log ( {S}_{1} / {S}_{2} ) , log ( {L}_{1} / {L}_{2} ) ) & ( Equation H )\end{matrix}$$

In the above Equation 4, Equation F is a calculation equation of an utterance source score F(X) with respect to input information X, and parameters of Equation F are shown as follows:

F(X): utterance source score with respect to input information X (weighted sum of outputs of all weak identifiers),
t(=1, . . . , T): number of weak classifier (total number being T),
Δt: weight equivalent to each of weak identifiers (reliability), and
ft(X): output of each of the weak identifiers with respect to input information X.

In addition, the weak identifier corresponds to elements constituting the identifier, and here, an example

in which the identified results of T-number of weak identifiers 1 to T are generalized to thereby calculate final identified results of the identifiers is shown.

Equation G is an example of input information in a case of using the identifier for determining whether the corresponding target is the utterance source, and parameters of Equation G are shown as follows:

D₁: sound source direction information,
S₁: utterer ID information, and
L₁: lip state information. In addition, the input information X is obtained by representing all of the above information by vectors.

In addition, Equation H shows an example of the input information in a case of using the identifier for determining which one of two targets is more like the utterance source.

The input information X is represented as a vector of a logarithmic likelihood ratio of the sound source direction information, the utterer ID information, and the lip state information.

The identifier calculates the utterance source score indicating the ID result of each target, that is, a probability value of the utterance source according to Equation F.

As described above, in the information processing apparatus of the present disclosure, the identifier for identifying whether each of the targets is the utterance source, or the identifier for determining which one of two targets is more utterance source with respect to only two pieces of target information is used. As the input information to the identifier, the sound source direction information or the utterer ID information included in the voice event information, the lip movement information included in the image event information within the event information, or the position of the target or the number of the targets included in the target information may be used. By using the identifier when calculating the utterance source probability, it is unnecessary that the weight coefficient described in BACKGROUND is adjusted beforehand, such that it is possible to calculate more appropriate utterance source probability.

A series of processes described throughout the specification can be performed by hardware or software or by a complex configuration of both. In the case of performing the process by software, a program in which the processing sequence is recorded is installed in the memory within a computer built into dedicated hardware to perform the process, or is installed in the general-purpose computer in which various processes can be performed to thereby perform the process. For example, the program may be recorded in a recording medium in advance. The program can be received via the network such as LAN (Local Area Network) and the Internet, other than by installing to the computer from the recording medium, and installed in the recording medium such as built-in hard disks, and the like.

In addition, various processes described in the specification may be performed in time series as described, and may be performed in parallel or individually in response to a processing capacity or a requirement of a device performing the process. In addition, the system throughout the specification is a logical set configuration of multiple devices, and it is not necessary that a device of each configuration is in the same housing.

The present disclosure contains subject matter related to that disclosed in Japanese Priority Patent Application JP 2010-178424 filed in the Japan Patent Office on Aug. 9, 2010, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. An information processing apparatus, comprising:
a plurality of information input units that inputs observation information of a real space;
an event detection unit that generates event information including estimated position information and estimated identification information of a user present in the real space based on analysis of the information input from the information input unit; and
an information integration processing unit that inputs the event information, and generates target information including the position and user identification information of each user based on the input event information and signal information representing a probability value for an event generating source,
wherein the information integration processing unit includes an utterance source probability calculation unit having an identifier, and calculates an utterance source probability based on input information using the identifier in the utterance source probability calculation unit.

2. The information processing apparatus according to claim 1, wherein:
the identifier inputs (a) user position information (sound source direction information) and (b) user ID information (utterer ID information) which are equivalent to an utterance event as input information from a voice event detection unit constituting the event detection unit,
inputs (a) user position information (face position information), (b) user ID information (face ID information), and (c) lip movement information as the target information generated based on input information from an image event detection unit constituting the event detection unit, and
performs a process of calculating the utterance source probability based on the input information by applying at least one piece of the information.

3. The information processing apparatus according to claim 1, wherein the identifier performs a process of identifying which one of target information of two targets selected from a preset target is an utterance source based on a comparison between the target information of the two targets.

4. The information processing apparatus according to claim 3, wherein the identifier calculates a logarithmic likelihood ratio of each piece of information included in target information in a comparison process of the target information of a plurality of targets included in the input information with respect to the identifier, and performs a process of calculating an utterance source score representing the utterance source probability according to the calculated logarithmic likelihood ratio.

5. The information processing apparatus according to claim 4, wherein the identifier calculates at least any logarithmic likelihood ratio of three kinds of logarithmic likelihood ratios such as log(D₁/D₂), log(S₁/S₂), and log(L₁/L₂) as a logarithmic likelihood ratio of two targets 1 and 2 using sound source direction information (D), utterer ID information (S), and lip movement information (L) as the input information with respect to the identifier to thereby calculate the utterance source score as the utterance source probability of the targets 1 and 2.

6. The information processing apparatus according to of claim 1, wherein:
the information integration processing unit includes a target information updating unit that performs a particle filtering process in which a plurality of particles is applied, the plurality of particles setting a plurality of target data corresponding to a virtual user based on the input information from the image event detection unit constituting the event detection unit, and generates analysis information including the position information of the user present in the real space, and
the target information updating unit sets by associating each packet of target data set by the particles with each event input from the event detection unit, performs updating of event correspondence target data selected from each of the particles in accordance with an input event identifier, and generates the target information including (a) user position information (face position information), (b) user ID information (face ID information), and (c) lip movement information to thereby output the generated target information to the utterance source probability calculation unit.

7. The information processing apparatus according to claim 6, wherein the target information updating unit performs a process by associating a target with each event of a face image unit detected in the event detection unit.

8. The information processing apparatus according to claim 6, wherein the target information updating unit generates the analysis information including the user position information and the user ID information of the user present in the real space by performing the particle filtering process.

9. An information processing method for performing an information analysis process in an information processing apparatus, the method comprising:
inputting observation information of a real space by a plurality of information input units;
detecting generation of event information including estimated position information and estimated ID information of a user present in the real space based on analysis of information input from the information input unit by an event detection unit; and
inputting the event information by an information integration processing unit, and generating target information including a position and user ID information of each user based on the input event information and signal information representing a probability value for an event generating source,
wherein, in the inputting of the event information and the generating of the target information and the signal information, an utterance source probability calculation process is performed using an identifier for calculating an utterance source probability based on input information when generating the signal information representing the probability of the event generating source.

10. A program causing an information processing apparatus to execute an information analysis process, the information analysis process comprising:
inputting observation information of a real space by a plurality of information input units;
detecting generation of event information including estimated position information and estimated ID information of a user present in the real space based on analysis of information input from the information input unit by an event detection unit; and
inputting the event information by an information integration processing unit, and generating target information including a position and user ID information of each user based on the input event information and generating signal information representing a probability value for an event generating source,
wherein, in the inputting of the event information and the generating of the target information and the signal information, an utterance source probability calculation process is performed using an identifier for calculating an utterance source probability based on input information when generating the signal information representing the probability of the event generating source.
